(19) United States
(12) Patent Application Publication
(10) Pub. No.: US 2005/0094856 A1
(43) Pub. Date: May 5, 2005

(54) Systems and methods for detecting target focus and tilt errors during genetic analysis

(76) Inventor: Scott R. Warren, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/700,372

(22) Filed: Nov. 3, 2003

(51) Int. Cl. G06K 9/00; G06K 9/40; B32B 5/02

(52) U.S. Cl. 382/129; 382/255; 422/82.05

(57) ABSTRACT

Systems and methods for positioning a camera target relative to a signal acquisition frame. Detection of the target's position deviation may be achieved by a calibration beam being reflected from the target surface and being detected by at least two position sensitive detectors (PSDs) to thereby allow removal of ambiguity in the target's Z-focus error from its tilt error. The PSD-measured quantities can be transformed into target control space quantities that can be used in a control loop to reduce the target position error. The calibration beam and one or more of the PSDs can also be used to detect the target's edges, thereby allowing lateral centering of the target relative to the reference frame.

### BACKGROUND

1. Field

The present teachings generally relate to the field of genetic analysis and more particularly to a system and methods for positional assessment and adjustment of an array analysis platform.

2. Description of the Related Art

Genetic analysis using arrays represents a powerful technique for detecting the presence and expression of many genes simultaneously. An array typically comprises a substrate surface containing a large number of closely packed probes each of which provide a means to selectively generate a signal when exposed to a particular sample species (e.g. DNA, RNA, protein). Discrimination and resolution of signals obtained from probe/sample hybridization generally requires precision instrumentation designed for very fine movement and measurement. During sample analysis, problems arise when performing signal acquisition due to positional deviations on or beyond the order of the feature size being observed. As an example, array analysis instrumentation routinely measures fluorescent emissions arising from closely packed nucleotide detection features on the micron (10⁻⁶ m) scale. In such circumstances, even small positional or reference frame deviations may result in imaging and analysis problems. Deviations such as these can occur for many reasons, including mechanical tolerance limitations, focusing hysterisis, and other positioning difficulties. To overcome the aforementioned limitations of conventional analysis platforms and to address the problems associated with analyzing progressively smaller and more complex arrays, the need for improved methods for microarray position detection and compensation becomes increasingly relevant.

### SUMMARY OF THE INVENTION

The present teachings relate to systems and methods for positioning a camera target relative to a signal acquisition frame. Detection of the target's position deviation may be achieved by a calibration beam being reflected from the target surface and being detected by at least two position sensitive detectors (PSDs) to thereby allow removal of ambiguity in the target's Z-focus error from its tilt error. The PSD-measured quantities can be transformed into target control space quantities that can be used in a control loop to reduce the target position error. The calibration beam and one or more of the PSDs can also be used to detect the target's edges, thereby allowing lateral centering of the target relative to the reference frame.

One aspect of the present teachings relates to a system for interrogating a sample using a probe array configured to be responsive to a plurality of particles. The probe array generates one or more identifiable signals following interaction with the sample particles. The sample composition is resolved, at least in part, by identifying the signals associated with each constituent probe of the array. The system comprises an imaging device capable of identifying signals associated with the constituent probes of the probe array. The position of each constituent probe and the signal arising therefrom is used to identify the presence or absence of particles contained within the sample. The system further comprises a focusing component that positions the imaging device and the probe array with respect to each other so as to obtain a desired focal orientation between the imaging device and the probe array. The system further comprises a focus detection system that includes a plurality of detectors. The focus detection system directs a calibration beam towards the probe array which is reflected with an orientation dependent on the positioning of the array. The calibration beam is subsequently split into a plurality of reflected beams which impinge upon the plurality of detectors such that the plurality of detectors detect the impingement positions of the plurality of reflected beams in at least two dimensions. The focus detection system uses the at least two dimensional impingement positions to determine how to move the image capture device and the probe array with respect to each other in order to position the imaging device and the probe array in the desired focal orientation. The system further comprises a processing system that evaluates signals captured by the imaging device when the probe array and the imaging device are in a desired focal orientation.

In one embodiment, the desired focal orientation is selected to improve the ability of the processing system to determine the physical location on the probe array from which each signal originates. In one embodiment, the desired focal orientation between the imaging device and the probe array is defined by at least the characteristics of (i) the deviation in the distance between the probe array and the imaging device (ΔZ), (ii) the tilt angle about a first axis θₓ and (iii) the tilt angle about a second axis θ_{Y}. In one embodiment, the focusing component preferably adjusts the focal orientation between the imaging device and the probe array such that the deviation in the distance between the probe array and the imaging device (ΔZ) is less than a pre-selected deviation in the distance and such that the tilt angle about the first and second axes θ_{X} and θ_{y} are such that the plane of the probe array is substantially parallel to a plane defined by the imaging device.

In one embodiment, the plurality of detectors comprise a first and a second detector. Each of the first and second detectors have a pre-selected location where the reflected calibration beams will impinge when the probe array and the imaging device are in the desired orientation. Each of the first and second detectors provide dimensional coordinates indicative of the offset between the actual point of impingement of the reflected beams and the pre-selected locations on the first and second detectors respectively.

In one embodiment, the dimensional coordinates are mathematically transformed using a calibration data set to define the values ΔZ, θ_{X} and θ_{Y}. In one embodiment, the mathematical transformation is performed by a least mean square estimate matrix that operates on a given set of dimensional coordinates to yield estimates of corresponding ΔZ, θ_{X} and θ_{Y} values. In one embodiment, the calibration data set comprises data points corresponding to dimensional coordinates obtained when the probe array is positioned at known ΔZ, θ_{X} and θ_{Y} focal orientations. In one embodiment, the data points corresponding to dimensional coordinates at known ΔZ, θ_{X} and θ_{Y} focal orientations are expressed as a transformation matrix (M) representative of a least mean square estimate of ΔZ, θ_{X} and θ_{Y} variables based on a given set of dimensional coordinates.

In one embodiment, the system further comprises a coarse focus system that positions the probe array proximate a desired location with respect to the imaging device prior to utilizing the focus detection system. In one embodiment, the coarse focus system comprises an iteration of a series of positional movements of the analysis platform. For a given series of positional movements, a best coarse focus is determined by selecting the position that yields the highest coarse focus metric value. The next series of positional movements comprises movement steps that are approximately half of the step size of the given series of movements. Such iteration of positional movements are performed until the step size is less than some specified value. In one embodiment, the coarse focus metric value comprises a contrast value determined by averaging the contrast the image at the image capture device.

Another aspect of the present teachings relates to an optical system comprising an analysis platform having a sample disposed on a probe array. Each probe is configured to be responsive to a specific particle. When the probe array is exposed to the sample, the probes generate identifiable signals based on the interaction of the probes with specific particles within the sample. The optical system further comprises an image capture device that captures an image of the probe array so as to be able to identify the position of the signal generating probes to thereby identify the composition of specific particles contained within the sample. The optical system further comprises a focusing component that positions the image capture device and the analysis platform with respect to each other so as to obtain a desired focal orientation between the image capture device and the analysis platform. The optical system further comprises a focus detection system that includes a calibration data set and a plurality of detectors. The focus detection system directs an energy beam towards the array of probes which is then reflected with an orientation dependent on the positioning of the array. The reflected energy beam is split into a plurality of reflected beams which impinge upon the plurality of detectors such that the plurality of detectors detect the impingement positions of the plurality of reflected beams in at least two dimensions. The focus detection system uses the at least two dimensional impingement positions and the calibration data to determine how the focusing component must relatively move the image capture device and the analysis platform with respect to each other in order to relatively position the image capture device and the analysis platform in the desired focal orientation. The optical system further comprises a processing system that evaluates the image captured by the image capture device when the analysis platform and the image capture device are in the desired focal orientation. The desired focal orientation is selected to improve the ability of the processing system to determine the physical location on the array of probes of the generated signals to thereby permit identification of the particle composition in the sample based upon the location of signals detected in the probe array.

In one embodiment, the probe array comprises a plurality of host sites adapted to selectively interact with a selected type of particle such that the spatial arrangement of the host sites allows spatial separation of particles from a mixture of different particles. The host sites are approximately coplanar such that host sites define a reflecting surface for the energy beam. The particles can be of nucleotide or protein origin, such as DNA or RNA molecules. In one embodiment, the particles are labeled with markers that emit a detectable signal when subjected to an excitation energy. In one embodiment, each host site comprises a fiber tip such that the probe array is formed by a bundle of the fibers with the tips being approximately coplanar with each other.

In one embodiment, the desired focal orientation between the image capture device and the analysis platform is defined by at least the characteristics of (i) the deviation in the distance between the analysis platform and the image capture device (ΔZ), (ii) the tilt angle about a first axis θ_{X} and (iii) the tilt angle about a second axis θ_{Y}. In one embodiment, the focusing component preferably adjusts the focal orientation between the image capture device and the analysis platform such that the deviation in the distance between the analysis platform and the image capture device (ΔZ) is less than a pre-selected deviation in the distance and such that the tilt angle about the first and second axes θ_{X} and θ_{Y} are such that the plane of the analysis platform is substantially parallel to a plane defined by the image capture device.

In one embodiment, the plurality of detectors comprise a first and a second two dimensional detectors. Each of the first and second detectors have a pre-selected location where the reflected energy beams will impinge when the analysis platform and the image capture device is in the desired orientation. Each of the first and second detectors provide two dimensional coordinates indicative of the offset between the actual point of impingement of the reflected beams and the pre-selected locations on the first and second detectors respectively.

In one embodiment, the two sets of dimensional coordinates are mathematically transformed using the calibration data set to define the values ΔZ, θ_{X} and θ_{Y}. In one embodiment, the mathematical transformation is performed by a least mean square estimate matrix that operates on a given set of dimensional coordinates to yield estimates of corresponding ΔZ, θ_{X} and θ_{Y} values.

In one embodiment, the calibration data set comprises data points corresponding to dimensional coordinates obtained when the analysis platform is positioned by the focusing component at known focal orientations. In one embodiment, the data points corresponding to dimensional coordinates at known focal orientations are expressed as a transformation matrix (M) that represents a least mean square estimate of the focal orientation based on a given set dimensional coordinates.

In one embodiment, the optical system further comprises a coarse focus system that positions the analysis platform proximate a desired location with respect to the image capture device prior to utilizing the focus detection system. In one embodiment, the coarse focus system comprises an iteration of a series of Z movements of the analysis platform. For a given series of Z movements, a best coarse focus is determined by selecting the Z position that yields the highest coarse focus metric value. The next series of Z movements comprises movement steps that are approximately half of the step size of the given series of movements. Such iteration of Z movements are performed until the step size is less than some specified value. In one embodiment, the coarse focus metric value comprises a contrast value determined by averaging the contrast the image at the image capture device.

Yet another aspect of the present teachings relates to a system for interrogating a sample via an array of probes positioned on an analysis platform. Each probe is configured to be responsive to a specific particle having unique identifying characteristics. When the array of probes is exposed to the sample, the probes generate an identifiable signal based on the interaction of the probes with specific particles within the sample based upon the unique identifying characteristics of the specific particle. The system comprises an image capture device that captures a two dimensional image of the array of probes so as to be able to identify the position of the signal generating probes to thereby identify the composition of specific particles contained within the sample. The system further comprises a focusing component that positions the image capture device and the analysis platform with respect to each other so as to obtain a desired focal orientation between the image capture device and the analysis platform. The system further comprises a focus detection system that includes a calibration data set and a plurality of detectors. The focus detection system directs an energy beam towards the array of probes which is then reflected with an orientation dependent on the positioning of the array. The reflected energy beam is split into a plurality of reflected beams which impinge upon the plurality of detectors such that the plurality of detectors detect the impingement positions of the plurality of reflected beams in at least two dimensions. The focus detection system uses the at least two dimensional impingement positions and the calibration data to determine how the focusing component must relatively move the image capture device and the analysis platform with respect to each other in order to relatively position the image capture device and the analysis platform in the desired focal orientation. The system further comprises a processing system that evaluates the image captured by the image capture device when the analysis platform and the image capture device are in the desired focal orientation. The desired focal orientation is selected to improve the ability of the processing system to determine the physical location on the array of probes of the generated signals to thereby permit identification of the particle composition in the sample based upon the location of signals detected in the array.

Yet another aspect of the present teachings relates to a method for obtaining a selected focal orientation between an imaging device and a probe array to resolve signals corresponding to a plurality of discrete probe species. The method comprises directing a calibration beam towards the probe array in such a manner so as to produce a reflected calibration beam having an orientation dependent, in part, upon the positioning of the probe array. The method further comprises splitting the reflected calibration beam into two or more reflected beams which subsequently impinge upon two or more beam detectors. The beam detectors detect the impingement positions of the two or more reflected beams in at least two dimensions. The method further comprises evaluating the impingement positions of the two or more reflected beams to determine the current positioning between the imaging device and the probe array. The method further comprises calculating positional adjustments necessary to position the imaging device and the probe array with respect to each other in the selected focal orientation. The method further comprises repositioning the imaging device and the probe array according to the calculated positional adjustments to achieve the selected focal orientation.

In one implementation, the selected focal orientation yields improved signal resolution when determining the physical location on the probe array from which each signal originates. In one implementation, the selected focal orientation between the imaging device and the probe array is defined by at least the characteristics of (i) the deviation in the distance between the probe array and the imaging device (ΔZ), (ii) the tilt angle about a first axis θ_{X} and (iii) the tilt angle about a second axis θ_{Y}. In one implementation, the focal orientation between the imaging device and the probe array is adjusted such that the deviation in the distance between the probe array and the imaging device (ΔZ) is less than a pre-selected deviation in the distance and such that the tilt angle about the first and second axes θ_{X} and θ_{Y} are such that the plane of the probe array is substantially parallel to a plane defined by the imaging device.

In one implementation, the imaging device receives the signals emitted by the probe array and subsequently generates an image representative of the probe array surface. In one implementation, the imaging device which receives the signals emitted by the probe array comprises a CCD element or photosensitive pixel array.

In one implementation, calculating positional adjustments further comprises determining a pre-selected location where the split reflected beams will impinge upon the beam detectors when the probe array and the imaging device are in the selected orientation. The first and second detectors provide dimensional coordinates indicative of the offset between the actual point of impingement of the reflected beams and the pre-selected locations on the beam detectors to provide a means for focal repositioning. In one implementation, the sets of dimensional coordinates are mathematically transformed using a calibration data set. In one implementation, the mathematical transformation is performed by a least mean square estimate matrix that operates on the sets of dimensional coordinates to yield estimates of deviation distance and tilt angles between the imaging device and the probe array. In one implementation, the calibration data set comprises data points corresponding to dimensional coordinates obtained when the probe array is positioned in known focal orientations. In one implementation, the data points corresponding to the dimensional coordinates at the known focal orientations are represented as a transformation matrix of a least mean square estimate of the deviation distance and tilt angles between the imaging device and the probe array.

In one implementation, the method further comprises performing a coarse focusing that positions the probe array proximate a desired location with respect to the imaging device prior to repositioning the imaging device and the probe array according to the calculated positional adjustments to achieve the selected focal orientation. In one implementation, the coarse focusing comprises an iteration of a series of movements of the probe array. For a given series of movements, a best coarse focus is determined by selecting the position that yields a highest coarse focus metric value. The next series of movements comprises movement steps that are approximately half of the step size of the given series of movements. Such iteration of movements are performed until the step size is less than a specified threshold. In one implementation, the coarse focus metric value is determined by averaging the contrast of the image of the probe array acquired by the imaging device.

Yet another aspect of the present teachings relates to a method for determining a focal orientation between an imaging device and a target. The method comprises directing a calibration beam towards the target in such a manner so as to produce a reflected calibration beam having an orientation dependent, in part, upon the positioning of the target. The method further comprises splitting the reflected calibration beam into two or more reflected beams which subsequently impinge upon two or more beam detectors. The beam detectors detect the impingement positions of the two or more reflected beams in at least two dimensions. The method further comprises evaluating the impingement positions of the two or more reflected beams to determine the current positioning between the imaging device and the target.

In one implementation, the method further comprises calculating positional adjustments necessary to position the imaging device and the target with respect to each other in the selected focal orientation. In one implementation, the method further comprises repositioning the imaging device and the target according to the calculated positional adjustments to achieve a desired focal orientation.

### BRIEF DESCRIPTION OF THE DRAWINGS

FIGS. 1A-B illustrates an exemplary arrays and signal acquisition devices.

FIG. 2A-2D illustrate exemplary positional deviations that may affect signal acquisition.

FIG. 3A illustrates a signal detection system adapted to position a target relative to a signal acquisition reference frame.

FIGS. 3B-3C illustrate various configurations of an exemplary fluorogenic bundle to be positioned in accordance with the present teachings.

FIG. 4 illustrates exemplary target deviations and a detection system capable of detecting such deviations.

FIG. 5 illustrates an exemplary calibration configuration wherein a target surface is positioned in a desired orientation relative to the signal acquisition reference frame.

FIGS. 6A-6C illustrate an exemplary calibration process wherein the target surface is positioned in a desired manner relative to the signal acquisition reference frame.

FIG. 7 illustrates a calibration process for associating position sensitive detector responses to various target positions.

FIG. 8 illustrates an exemplary process for positioning of a target relative to the signal acquisition reference frame.

FIGS. 9A-9D illustrate an exemplary process for bringing a target into focus.

FIG. 10 illustrates a process for reducing target positioning error relative to the signal acquisition reference frame.

FIG. 11 illustrates a process for transforming position sensitive detector data into target control space information to be used in target positioning.

FIG. 12 illustrates a functional block diagram of a target control space loop that reduces target position error relative to the signal acquisition reference frame.

FIGS. 13A-13B illustrate a method utilizing signal reflection to detect a target edge.

FIG. 14 illustrates a process for target centering with respect to a signal acquisition reference frame.

FIGS. 15A-15B illustrate some exemplary target shapes and their corresponding target centering geometries.

FIG. 16 illustrates an exemplary stage assembly having a target mounted thereon that allows positioning of the target relative to the signal acquisition reference frame.

### DETAILED DESCRIPTION OF CERTAIN EMBODIMENTS

These and other aspects, advantages, and novel features of the present teachings will become apparent upon reading the following detailed description and upon reference to the accompanying drawings. In the drawings, similar elements have similar reference numerals.

It will be appreciated that the system and methods disclosed herein possess a wide range of applicability; for example, the present teachings may be used in conjunction with visible/fluorescent label detection associated with array analysis. By way of introduction, array detection technologies encompass a number of different analytical platforms that may be used to detect the presence of one or more target species (e.g. DNA, RNA, proteins, and other biological and non-biological molecules). These technologies are distinguishable from other conventional analytical methods by virtue of their ability to selectively and simultaneously monitor the presence many hundreds, if not thousands, different molecules contained within a sample. Additionally, these technologies provide a relatively high degree of detection sensitivity that may yield both qualitative and quantitative results to thereby provide an attractive alternative to conventional analytical techniques including gel electrophoresis and membrane blotting as a means to perform rapid multi-component analysis in an efficient and reliable manner.

In the context of genetic analysis, array technologies desirably provide a “global perspective” wherein the presence and expression of a large number of genes or proteins may be investigated in a single experiment. Simultaneous genetic evaluation in the aforementioned manner has many applications including, but not limited to: characterization of genetic sequences, mutation and single nucleotide polymorphism (SNP) detection, and expression analysis. Furthermore, array-based approaches may provide valuable insight into biological functions and responses in a manner that would be impractical to perform by conventional methods.

As will be appreciated by one of skill in the art, the terms “array” and “microarray” encompass any of a number of related technologies which may include, by way of example: biochips, DNA chips, DNA microarrays, gene arrays, genome arrays, spotted arrays, protein arrays, fluorogenic bundles, and the like. In one aspect, an array may comprise a high density, oligonucleotide-based array which may be used to assay a large number of different genes simultaneously through selective base-pairing (e.g., A-T and G-C for DNA; A-U and G-C for RNA).

In the context of genetic analysis, an array comprises an orderly arrangement of base sequences or other probes which serve as a means to match known and unknown sample components through complementary binding, reaction or hybridization. Arrays are constructed in various sizes and typically possess a plurality of features or probe areas with each corresponding feature generally equating to the area occupied by a singular probe species. To accommodate simultaneous analysis of a large number of sample components, the feature size for each probe species is generally very small (on the order of 200 microns in diameter or less) with the array capable of containing many thousands of such features closely positioned with respect to one another.

In one embodiment, during array-based genetic analysis, information regarding the abundance of specific nucleotide sequences contained within the sample may be acquired by identifying the amount or intensity of signals emanating from each probe species following exposure to an experimental sample. In one aspect, one or more signals may be generated comprising fluorescent or visible light of various wavelengths which radiate from a selected feature element as a result of specific hybridization between components contained within the sample and selected probes positioned on the array. Therefore, measuring the amount of fluorescence or visible light emitted by each feature element provides an indication of the quantity of a particular component present within the sample on the basis of knowledge of the composition and placement of probes within the array.

In conventional data acquisition systems used in connection with array-based analysis, difficulties arise when associating acquired signals with the probe or feature element from which they arise. Signal acquisition errors may arise as a result of positional variability or misalignment of the array during analysis and improper or insufficient signal resolution between feature areas. Errors such as these are undesirable and may lead to improperly associating fluorescence or light intensities acquired during signal acquisition with the correct probe species. The closely positioned nature of the probes, as well as, the relatively small feature size particularly exacerbates this problem and, if left uncorrected, may result in significant degradation in the accuracy of the analysis.

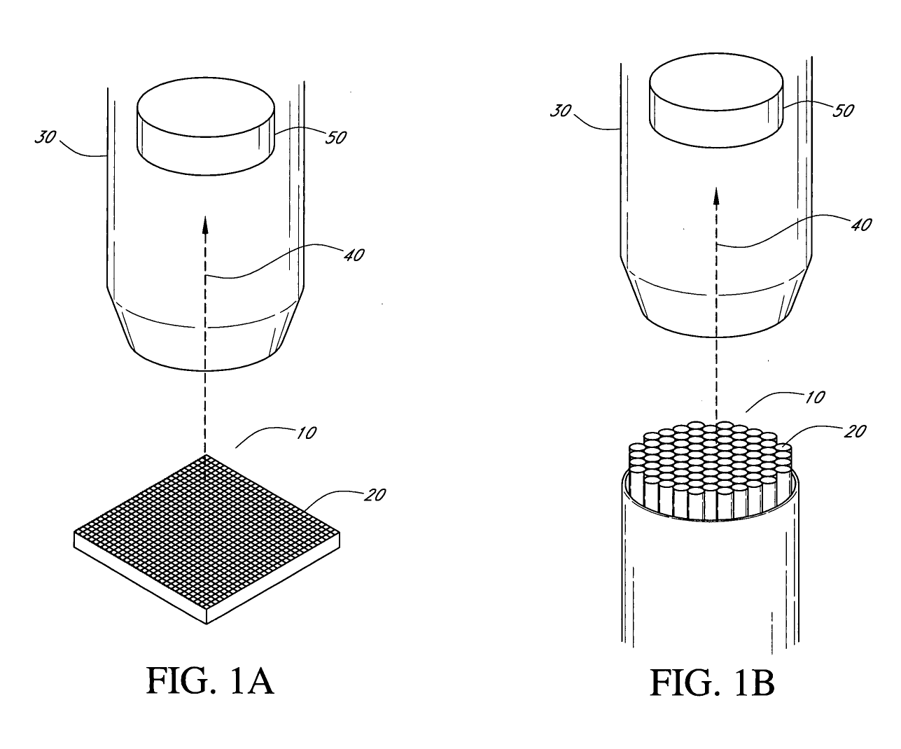

FIGS. 1A-B and 2A-2D illustrate some of the principals of data acquisition for exemplary array platforms. As shown in FIGS. 1A-B, an array 10 comprising a plurality of individual probes or feature elements 20 is positioned in proximity to a detector 30. Each array 10 may comprise any of a number of different analysis platforms designed to interrogate a plurality of discrete target species. For example, as shown in FIG. 1A, the array 10 may comprise a substrate surface upon which a plurality of individual probe species reside. Likewise, the array may comprise a fiber bundle or similar composite surface upon which the probe species are contained wherein each fiber strand in the bundle desirably contains one or more discrete probe species whose signals are to be ascertained upon binding to one or more target species. Additional details of the array composition and design will be described in greater detail hereinbelow.

The detector 30 evaluates signals 40 emanating from each probe 20 contained on the array 10 by finely aligning a signal capture or detection element 50 in such a position so that the signals 40 from one or more selected probes 20 are acquired. The acquired signals 40 are subsequently associated with the amount of hybridization which occurred for a selected probe species and, in one aspect; calculations may be performed using the signal intensities to determine the relative concentration of target present in a sample.

It will be appreciated that the detector 30 may acquire signals 40 for one or more probes 20 on a selective basis or alternatively the signals 40 for a portion or the entirety of the arrays 10 may be acquired simultaneously and subsequently resolved to yield the individual probe signals 40. Consequently, in the following description of position and orientation-related signal acquisition difficulties and methods for overcoming such limitations, the manner of signal acquisition may relate to any of the aforementioned methods for detector data acquisition. Similarly, the methods for positional assessment and adjustment to align or resolve the orientation of the array 10 with respect to the detector 30 may be applied to substantially any manner of data acquisition.

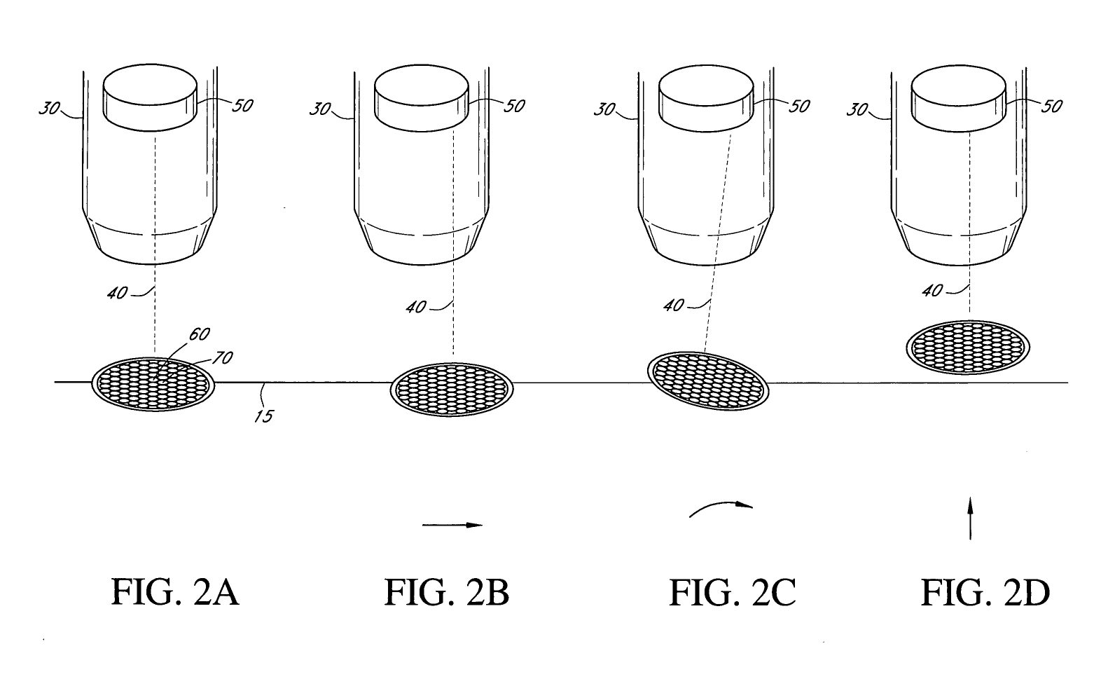

FIGS. 2A-2D illustrate various positioning errors or misalignments of the array 10 with respect to the detector 30 that can result in diminished sensitivity or improper signal registration during probe signal acquisition leading to undesirable quantitation errors. FIG. 2A is an illustration depicting proper alignment of the array 10 with respect to the detector 30 in a desired or optimal focal plane or position 15. When properly aligned, the signal 40 arising from a selected feature element 60 is acquired by the signal detection element 50 in such a manner so as to be resolvable from other surrounding feature elements 70. Proper alignment in this manner yields a resolvable signal having a magnitude that may be equated to the sample component concentration.

FIGS. 2B-2D illustrate simplified exemplary positioning errors wherein the array 10 is displaced in various orientations with respect to the detector 30 resulting in the signal detection element 50 potentially misregistering the signal intensity associated with the selected feature element 60. In one aspect, signal misregistration may occur as a result of the array 10 or the selected feature element 60 being “out of focus” with respect to the signal detection element 50 resulting in a loss of resolution when distinguishing signals arising from adjacent features.

FIGS. 2B and 2C illustrate exemplary lateral and rotational displacements of a selected feature element 60 from the desired focal plane 15 which may result in signal misregistration or an “out of focus” condition. In such circumstances, signal misregistration may arise as a consequence of an element being improperly positioned resulting in a selected probe species signal 40 being: partially detected, missed entirely, partially obscured, or wholly obscured by surrounding signals. As shown in FIG. 2D, another potential misregistration problem may arise when the array 10 is displaced vertically out of the desired focal plane 15 resulting in an “out of focus” image. In each of the aforementioned instances of positional displacement away from the desired focal plane 15, signals from surrounding feature elements may undesirably combine with, obscure, block, replace, or otherwise interrupt the detector's ability to resolve the signal 40 arising from the selected feature element 60. Such misregistration problems may obscure the boundaries between features creating difficulties in resolving the signals emanating from adjacent features which may not be easily distinguished even through subsequent software interpolation techniques. It will be appreciated that the diminutive size and density of features within a typical array is such that these positional deviations are particularly troublesome when attempting to resolve the individual signals arising from particular features or probes. In some instances, a positional deviation may lead to inappropriate probe-signal matching if left uncorrected. Additionally, one or more signals may crossover spatially with respect to one another presenting potential difficulties in signal resolution.

The present teachings provide means to identify and correct for positional deviations such as those described above whereby each signal acquired by the detector 30 accurately reflects the feature element or probe 60 from which the signal arose with respect to position and magnitude. In one aspect, the present teachings may be used to actively correct the array position during analysis and signal acquisition to insure proper alignment of the array 10 with respect to the detector 30. Additionally, the present teachings may be used to assess the orientation of the array 10 with respect to the detector 30 during analysis and subsequently compensate for positional deviations which might otherwise lead to signal misregistration. The present teachings, further describe means by which the array's position may be evaluated prior to analysis to help maintain an appropriate array position and orientation to improve signal acquisition and resolution. Other benefits and implementations of the positional evaluation and correction scheme will be disclosed in greater detail hereinbelow.

The following description details various aspects and embodiments of a system and methods for positional assessment and correction according to the present teachings. As will be appreciated by one of skill in the art, the following description may be applied to a number of different optical systems requiring precision alignment and target recognition. In particular, the system and methods described herein may be applied to array analysis instrumentation wherein high-density probe generated-signals may be resolved by ascertaining the position and orientation of an array upon which a plurality of probes reside. Furthermore, the methods described herein may be used to preemptively correct positional deviations associated with array placement to aid in focusing and may also be applied to signal resolution following data acquisition.

As described above, these teachings are not limited to a particular class or type of array and may be used in conjunction with numerous different categories of arrays used in scientific analysis. It will be further appreciated that substitution of the components described herein may be readily performed to accommodate different implementations of signal acquisition instrumentation. For example, the previously described signal detection element 50 may comprise a charge coupled device (CCD), camera, photosensitive pixel array, or other suitable component for acquiring signals generated by the probes. Likewise, the probe-generated signals 40 need not necessarily be limited to only fluorescent or visible light emissions and may comprise other types of signals which may be acquired by the detector 30.

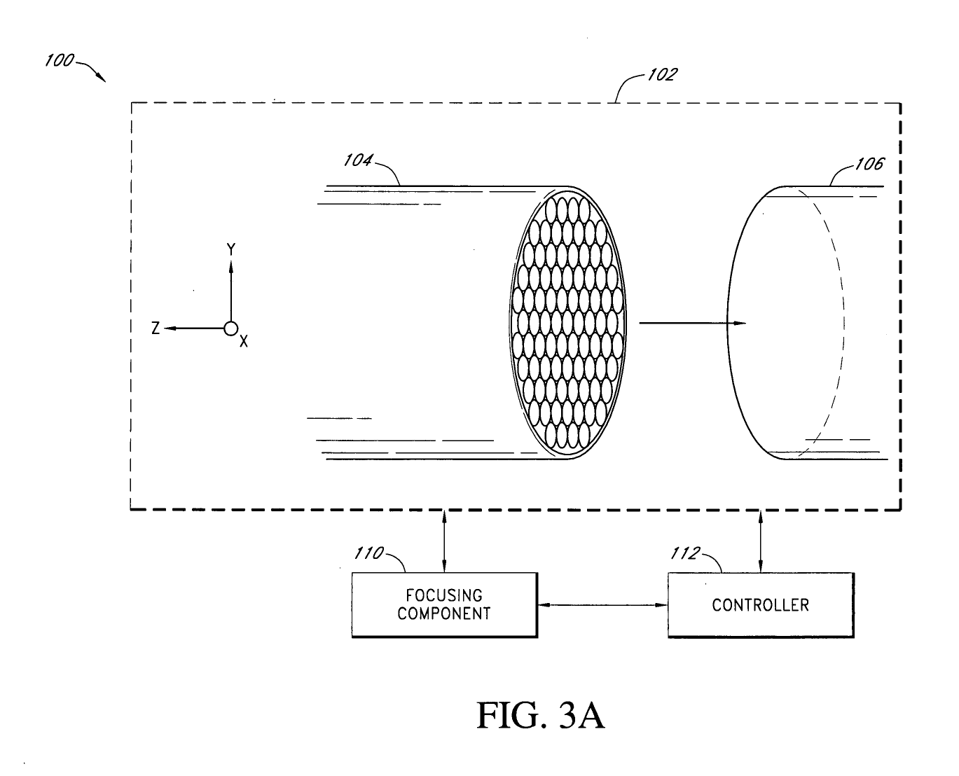

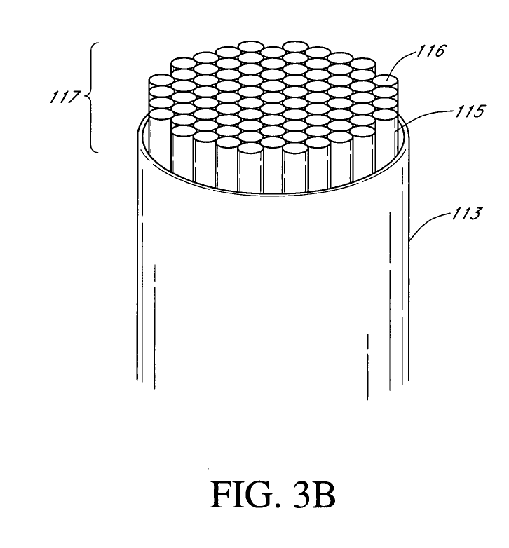

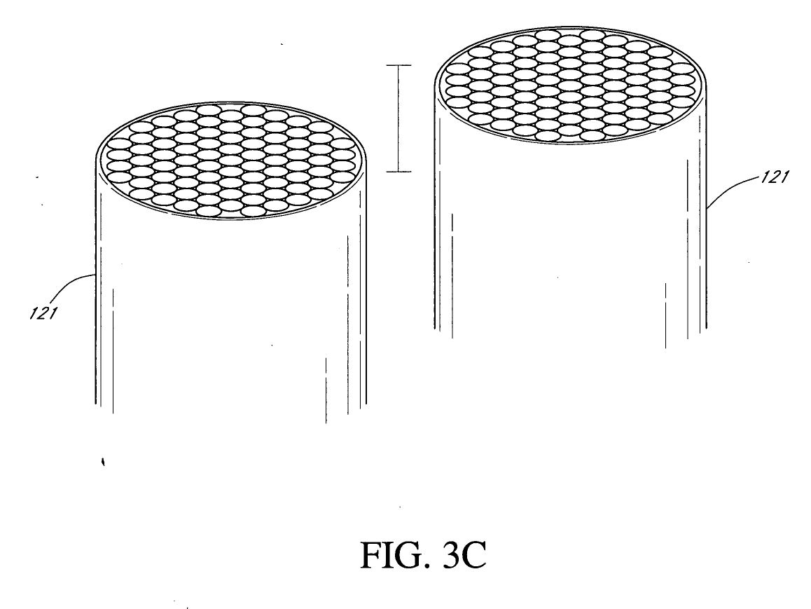

FIG. 3A illustrates a functional diagram of a sample processing system 100 comprising a signal resolution component 102 controlled by a controller 112 via a focusing component 110. In particular, the signal resolution component 102 comprises a sample or target 104 positioned relative to a signal acquisition component 106. In one aspect, the controller 112 and the focusing component 110 detect and correct positional errors associated with orientation of the target 104 relative to the signal acquisition component 106 in a manner described below in greater detail.

In the context of array-based analysis, the sample processing system 100 may comprise an array reader or data acquisition device designed to receive an array or other analytical component upon which a plurality of probes are arranged in a known order and from which one or more signals emanate. Examples of array readers may include instrumentation used in connection with evaluating probe signals originating from nucleotide or protein-based arrays, as well as, arrays designed to assess other biological and non-biological compounds and elements.

The aforementioned target 104 may be regarded as the “optical object” of the sample processing system 100 and is desirably oriented in such a manner so as to direct signals emanating from the target 104 towards the signal acquisition component 106. It will be appreciated that the signals may be directed towards the signal acquisition component either directly or indirectly (e.g., via mirrors, diffraction gratings, lenses or other means). The target 104 may further comprise any of a number of objects from which signals are desirably identified and resolved. In various embodiments, the target 104 may comprise a hybridization-based nucleotide detection platform wherein a plurality of nucleotide probes are affixed to a substrate (e.g., glass, silicon wafer, fiber bundle, etc.) and from which various signals (e.g., visible or fluorescent light) are emitted based on selective hybridization between the probe and constituent molecules present in a sample undergoing analysis. In certain embodiments, the target 104 may be mounted on a movable stage that allows movement of the target 104 relative to the signal acquisition component 106 in a manner described below in greater detail. The signal acquisition component 106 may be representative of a focal plane of the signal resolution component 102 and serves to capture or acquire an image, representation or sampling of the signals produced by the target 104. As previously described and in various embodiments, the signal resolution component 102 may include, by way of example, a CCD, a photographic film element or other signal-sensitive devices.

Although the signal resolution component 102 does not specifically illustrate optical elements, it will be understood that the image of the target 104 or signals arising therefrom are registered on the signal acquisition component 106. Focusing of the signals originating from the target 104 may be achieved through the use of an adjustable-focus optical element(s), or by positioning the target 104 with respect to a fixed focus optical element(s), or by a combination(s) thereof.

In general, it is desirable to achieve a certain positioning of the target 104 relative to the reference frame 106. In certain embodiments, this positioning is achieved when the center of the target 104 is at a proper focal length along the Z axis, and the plane defined by the target 104 is centered and substantially parallel with respect to the plane defined by the reference frame 106. It will be understood that other configurations of the target and/or the reference frame may be utilized in the optical system. For example, the target and/or the reference frame may be curved to accommodate optical aberrations (if any). The novel concept of detecting and correcting for the target position deviations described herein may also be adapted and applied to such a configuration without departing from the spirit of the present teachings.

FIGS. 3B-3D illustrate exemplary target deviations which may affect focusing with respect to the reference component 106. In FIG. 3B an idealized fiber bundle 113 is illustrated wherein a plurality of signal-generating fibers 115 are arranged in proximity to one another. In one aspect, each fiber 115 is fabricated in a manner so as to provide a support surface 116 for a probe construct which acts in conjunction with a target species to generate a signal which is subsequently detected by the detector. The fibers 115 may be surface coated with the probe by various known chemistries or alternatively a probe coated bead or other suitable substrate may be used in connection with the fiber to direct the signal as desired.

As previously described, the size of each fiber 115 may be relatively small in order to accommodate grouping together of a relatively large number of fibers 115 to be used during sample analysis. In general, it is desirable to fabricate the fiber bundle 113 such that the end surfaces 116 of the fibers 115 form a relatively uniform bundle surface 117. The uniform bundle surface 117 aids in signal recognition by the detector and helps to improve discrete signal resolution for each probe species.

In another aspect, the fiber bundle surface may lack perfect uniformity. Such a fiber bundle may present analysis difficulties as there may be various degrees of offset between each fiber in the fiber bundle. The present teachings address this type of alignment variability and provide means to correct for its presence as will be described in greater detail hereinbelow. FIG. 3C further illustrates another form of offset wherein two fiber bundles 121 may be displaced with respect to one another. As with internal fiber orientation and positional deviations, the present teachings provide means to assess and correct for such occurrences thereby improving the ability to resolve high density signals in relatively small and/or closely packed arrays.

The aforementioned description of fiber bundle positional deviations represent but a few of the many different types of possible alignment difficulties which may be encountered when analyzing an array 10. Other array and system deviations which may occur include, by way of example, focus (Z axis) motor hysterisis error, target tilt error, target surface uniformity error, focus calibration error, and thermal drift error. It will be appreciated that the system and methods described herein may be readily adapted to accommodate other types of positional and orientational deviations as well as other types of array designs. Additionally, the present teachings may be utilized in other contexts outside of the scope of arrays to address other problems in which positional and orientational variability may affect data acquisition and analysis.

To illustrate the net result of how such errors may be significant with respect to the feature size being measured, an exemplary error profile for an exemplary array signal detection system is considered. In one embodiment, the target comprises a bundle of fluorogenic substrate fibers (such as that utilized in the LightBright detection system, Applied Biosystems, CA) whose tips collectively define the target surface. Alternatively, the target may comprise an array surface from which a plurality of probes are positioned and from which fluorescent signals emanate. In such target systems, the Z focus hysterisis error may be approximately 0.3 μm, the tilt error may be approximately 0.9 μm, and the surface “roughness” may be approximately 0.5 μm. Such errors add in quadrature to yield a random error of approximately 1.05 μm. The signal detection system may also utilize a focusing algorithm having a focus calibration error of approximately 0.5 μm. Thus, in various embodiments, a total focus and target related error may be approximately 1.57 μm, which is on the order of the fiber diameter dimension. Such an error is problematic when the signals emanating from the tip of each fiber are to be measured and distinguished from one another. The present teachings disclosed herein detect such position errors and reduce the overall position deviation to improve the accuracy of target positioning with respect to the reference frame.

From the foregoing, it should be appreciated that in order to effectively resolve the features of the target (for example, the fiber tip diameter in the μm order of magnitude), such features preferably should not deviate from their optimal optical orientations by substantially more than the approximate feature dimension size. That is, when a particular feature on the target deviates significantly from its optimal position (“out of focus”) a reduced quality result may be obtained. Reduced quality results may comprise diminished detected signal magnitude, improper feature registration or signal association, signal “spillover” between adjacent features, or other undesirable effects which may result in difficulties or errors when quantitating and distinguishing the signals associated with each feature. In various embodiments, the feature may be out of focus due to a target tilt (where one part may be in focus, but other parts may be out of focus), a Z-shift (where substantially entire target may be out of focus), or any combination thereof. The present teachings allow such deviations to be detected and corrected as necessary to achieve an overall focus within a specified accuracy.

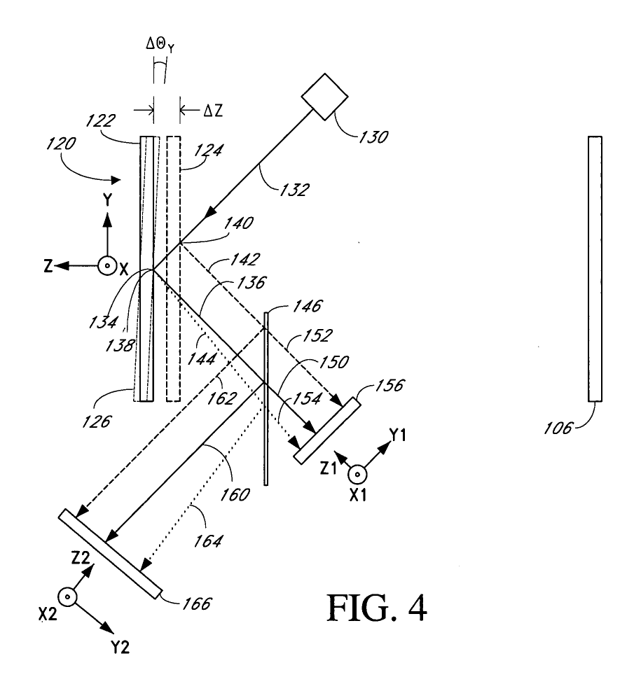

In FIG. 4, a target 120 is depicted as being in a desirable or optimal position 122, a Z-shifted position 124, and a tilted position 126. Of course, the target 120 could be in any combination of the Z-shift and tilted positions, but each “mode” of deviation is considered separately for clarity. The signal detection system includes a target position deviation detection system 128 comprising a light source 130 that directs an incident light 132 to the target 120. In certain embodiments, the orientation of the incident light 132 is substantially fixed relative to the signal acquisition frame. In other embodiments, the incident light 132 orientation with respect to the reference frame may be adjusted with sufficient accuracy and reproducibility so as to be useful for detecting the target position deviations.

When the target 120 is in the desired or optimal position 122, the incident light 132 impinges on the target 120 at a point 134 and reflects generally in a specular manner to yield a reflected light 136. Similarly, when the target 120 is in the Z-shifted position 124, the incident light 132 impinges on the target 120 at a point 140 and yields a reflected light 142. Similarly, when the target 120 is in the tilted position 126, the incident light 132 impinges on the target 120 at a point 138, which may or may not be the same as the point 134, and yields a reflected light 144.

It will be appreciated that the term “light” (such as usage for light 132 and light source 130) herein is not intended to be limited to the visible spectrum as generally understood. Other forms of electromagnetic energy, such as infrared, ultraviolet, and other radiation types may be used without departing from the spirit of the present teachings.

The target position deviation detection system 128 further comprises a first position sensitive detector (PSD) 156 and a second PSD 166 positioned at selected locations with respect to the target 120 and the reference frame. The detection system 128 in FIG. 4 is also depicted as having a beam splitter 146 adapted to split and direct the reflected light to the first and second PSDs 156, 166. In certain embodiments, the beam splitter 146 may comprises a semi-transparent mirror that allows partial transmission and partial reflection of light. It will be appreciated, however, that any numerous other means of splitting the beam may be employed without departing from the spirit of the present teachings.

The target-reflected light 136 is thus split into a light 150 to the first PSD 156 and a light 160 to the second PSD 166. Similarly, the target-reflected light 142 is split into a light 152 to the first PSD 156 and a light 162 to the second PSD 166. Similarly, the target-reflected light 144 is split into a light 154 to the first PSD 156 and a light 164 to the second PSD 166.

It can be seen that a pure Z shift of the target 120 (between positions 122 and 124) results in the target-reflected lights 136 and 142 being substantially parallel. Furthermore, when the partial transmission/reflection beam splitter 146 is utilized, the resulting lights (due to the pure Z-shift) to the first and second PSDs 156 and 166 are also substantially parallel. As such, the detected locations of the lights 150, 152 on the first PSD 156 and the lights 160, 162 on the second PSD 166 are generally independent of the distance of the PSDs from the target 120.

It can also be seen that for a tilt shift of the target 120 (between positions 122 and 126) results in the target reflected lights 136 and 144 diverging from the reflection points 134, 138. Furthermore, when the partial transmission/reflection beam splitter 146 is utilized, the detected location spacings of the lights 150, 154 on the first PSD 156 and the lights 160, 164 on the second PSD 166 depend on the optical pathlengths of the PSDs from the target 120. Specifically, the spacing of the detected light at a given PSD for a given tilt is proportional to the optical pathlength of the given PSD from the target.

From the foregoing description in reference to FIG. 4, it can be seen that with only one PSD at a fixed location, it may be difficult or impossible to ascertain whether a set of two detected lights is due to a Z-shift or a tilt. Having a second PSD allows such determination in a manner described below in greater detail. In certain embodiments, the signal detection system comprises two independent PSDs located at substantially fixed locations with respect to the signal acquisition frame. In other embodiments, a single PSD may be adapted to be moved between a first and a second location with sufficient accuracy and reproducibility to provide similar capability as that of the two-PSD system without departing from the spirit of the present teachings.

In certain embodiments, the target-reflected light's PSD position corresponding to the target's optimal position 122 is predetermined. As such, any deviation of a detected light's position (from that corresponding to the optimal position) on a given PSD represents a position deviation of the target 120. As previously mentioned, the target 120 may deviate from the optimal position 122 in any combination of Z-shift and tilt. Thus, a given target position deviation form the optimal position may include the effects of Z-shift and the tilt. One aspect of the present teachings relates to utilizing the detected positions on the two PSDs to uncouple the Z-shift effect from the tilt effect, thereby allowing corrections to compensate for the two deviation modes separately. The methodology for such a technique is described below in greater detail.

In FIG. 4, the desired or optimal position 122 of the target 120 is depicted to be in an X-Y plane, and the first and second PSDs 156 and 166 are depicted to be in X1-Y1 and X2-Y2 planes, respectively. Furthermore, the incident light 132 and the reflected lights 136, 142, and 144 define a plane that is coplanar with the Y-Z, Y1-Z1, and Y2-Z2 planes. As such, the Y1 deviation on the first PSD 156 and the Y2 deviation on the second PSD 166 represent the Z-shift (ΔZ), tilt of the Y axis (Δθ_{Y}), or the combination thereof the target 120 with respect to the optimal position 122.

It will be understood that the target 120 may also deviate so as to tilt the X-axis (Δθ_{X}), alone, or in conjunction with any of the above-described combination of the Z-shift and the Y-tilt. The X-tilt will be manifested in deviations of detected light along the X1 and X2 axes. Thus, the concept of uncoupling the ΔZ and the Δθ_{Y} via the Y1 and Y2 measurements previously mentioned above can be naturally extended such that the target deviation can be uncoupled to ΔZ, Δθ_{X}, and Δθ_{Y} via the measurements of X1, Y1, X2, Y2 of the first and second PSDs 156 and 166. It will also be understood that the target's and the first and second PSD's coordinate systems orientations illustrated in FIG. 4 is one of many possible selections, and is in no way meant to limit the scope of the present teachings. Any one of other coordinate system conventions may be used without the loss of generality or departing from the spirit of the present teachings.

In FIG. 4, the deviation of the target 120 is depicted to be in ΔZ and Δθ_{Y}(and also Δθ_{X} by extension) for clarity of illustrating the interdependence of the Z-shift and the tilt on the reflected light. The target may also deviate laterally (along the X-Y plane) with respect to the signal acquisition frame. The lateral deviation of the target, however, generally does not alter the geometry of target-reflected light.

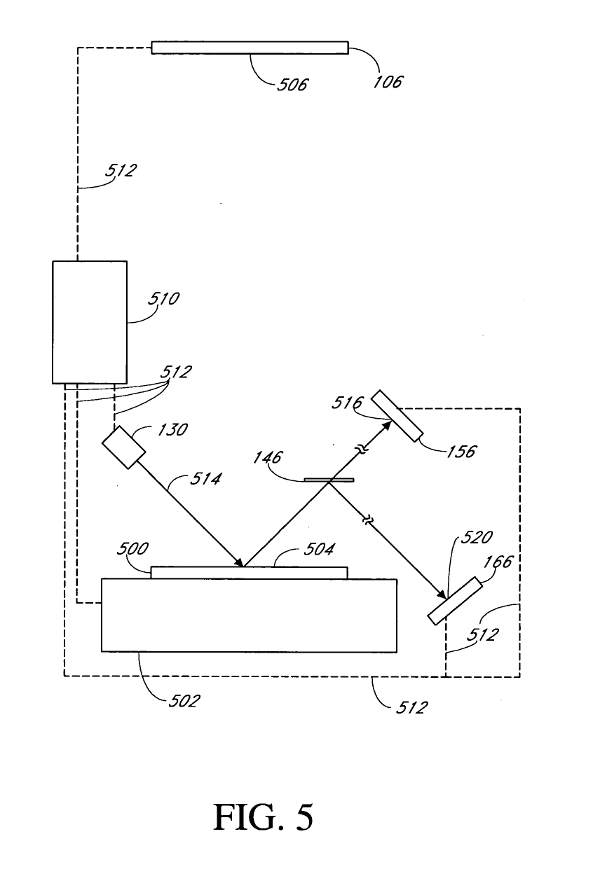

The two PSDs described above in reference to FIG. 4 may be utilized to determine the position of the target with respect to the reference frame. Preferably, such determination can be made during a “run” condition on a sample-bearing surface of the target. In one aspect, a calibration of the target's position relative to the reference frame allows such run-time position determination to be made in an efficient manner. FIGS. 5-7 illustrate one possible calibration method that may be performed prior to the run and does not need to be repeated during the run.

FIG. 5 illustrates a target 500 positioned relative to the reference frame 106 so as to be moved in a controllable manner as described below. In certain embodiments, the target 500 may be mounted on a stage 502. The stage 502 is positioned relative to the reference frame 106 via a relative positioning mechanism 510. The positioning mechanism 510 allows the reference frame 106, stage 502, light source 130, and the first and second PSDs 156, 166 to be positioned relative to each other with a specified level of accuracy. Such substantially known positioning of the components are indicated by dashed lines 512, and may be achieved, by way of example, by precision mechanical interconnection, by having the various components' orientations surveyed relative to each other, or by some combination thereof. It will be appreciated that various possible methods may be employed to yield the substantially known positioning of the components without departing from the spirit of the present teachings.

In certain embodiments, the target 500 is dimensioned such that its first surface 504 is in a substantially known orientation with respect to the stage 502. Thus, the first surface 504 is in a substantially known orientation with respect to a first surface of the reference frame 106. Such target 500 may be a specially fabricated calibration target or a selected target(s) having known dimensions and other characteristics that make them suitable for calibration purposes.

Using the target 500 mounted in the foregoing manner, a light 514 from the light source 130 reflecting from the first surface of the target 500 results in the reflected light being registered at points 516 and 520 on the first and second PSDs 156, 166, respectively. For a given substantially fixed and known orientation of the components (indicated by the dashed lines 512), the registered points 516 and 520 are substantially unique and correspond to the orientation of the first surface 504. Thus, by varying the orientation of the first surface 504 and determining the corresponding values from the first and second PSDs 156, 166, one can calibrate the responses of the PSDs for future use.

Preferably, such calibration is performed prior to a data taking run. The calibration may be performed when the optical system is initially set up, prior to each data taking run, or any combination thereof. Initially, some independent means of verifying the relative target-reference frame orientation may be utilized. Such means may include, for example, precision surveying of the components to ascertain the relative positions of the various components with specified precision.

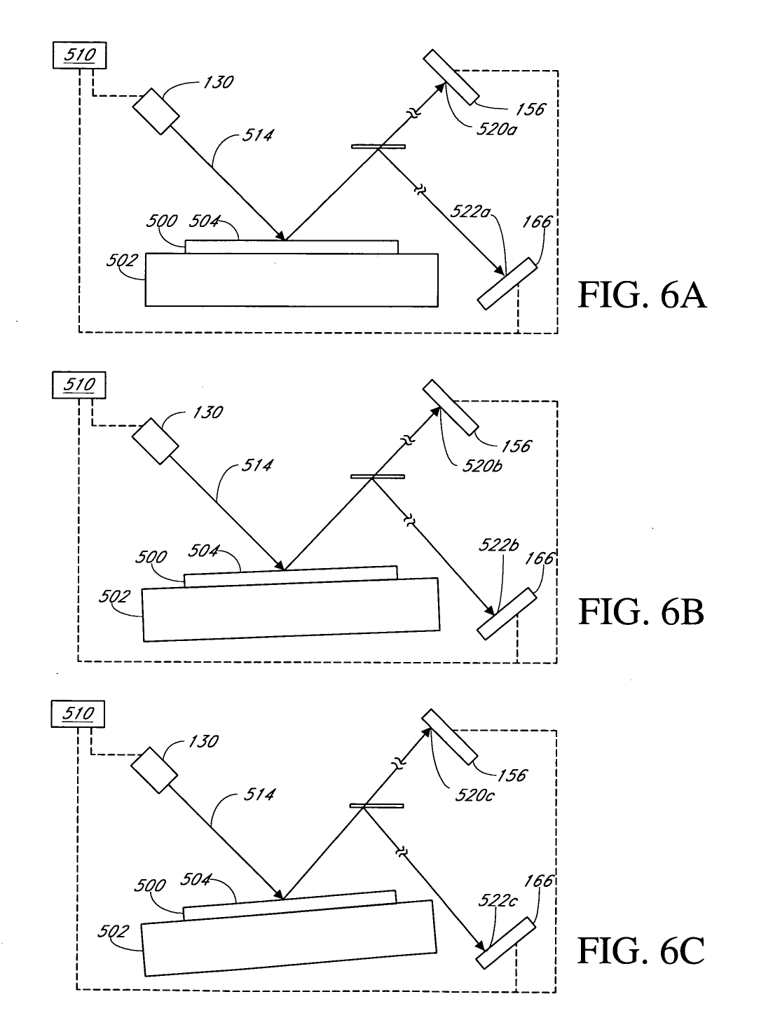

Once the target-reference frame orientation is established, a plurality of PSD readings may be obtained at various target orientations, as illustrated in FIGS. 6A-C. FIG. 6A illustrates the first target surface 504 in a first orientation, yielding datapoints 520a and 522a from the first and second PSDs 156 and 166, respectively. As previously described, the first and second PSDs 156 and 166 are in substantially known orientations relative to the reference frame's first surface (not shown). Thus, the first and second PSDs' datapoints 520a and 522a correspond to the first orientation of the first surface 504 with respect to the reference frame.

FIG. 6B illustrates the first target surface 504 in a second orientation, yielding datapoints 520b and 522b from the first and second PSDs 156 and 166, respectively. The transition of the first target surface 504 from its first orientation to the second orientation may be achieved by controllably moving the stage with specified precision. An example of a stage suitable for such movement is described below. Thus, the first and second PSDs' datapoints 520b and 522b correspond to the second orientation of the first surface 504 with respect to the reference frame.

FIG. 6C illustrates the first target surface 504 in a third orientation, yielding datapoints 520c and 522c from the first and second PSDs 156 and 166, respectively. Thus, the first and second PSDs' datapoints 520c and 522c correspond to the second orientation of the first surface 504 with respect to the reference frame.

Such movements may continue to cover the desired range of movements, with PSD datapoints obtained therefrom corresponding to substantially known orientations of the first surface 504. Although FIGS. 6A-C illustrate a tilt calibration movement, it will be appreciated that such depiction is for illustrative purpose only, and is not meant to limit the scope of the calibration movements. Other stage movements, such as Z-shifts and combination of Z-shift and tilt (in both X and Y) may be performed without departing from the spirit of the present teachings.

Once a plurality of datapoints from PSDs corresponding to substantially known target surface orientation are obtained, such data may be stored and retrieved at a later time to allow determination of an unknown target surface orientation during a run from its corresponding PSD values. Such PSD values to target surface orientation determination (based on the calibration data) may be performed in a number of ways, including a matrix based transformation method described below.

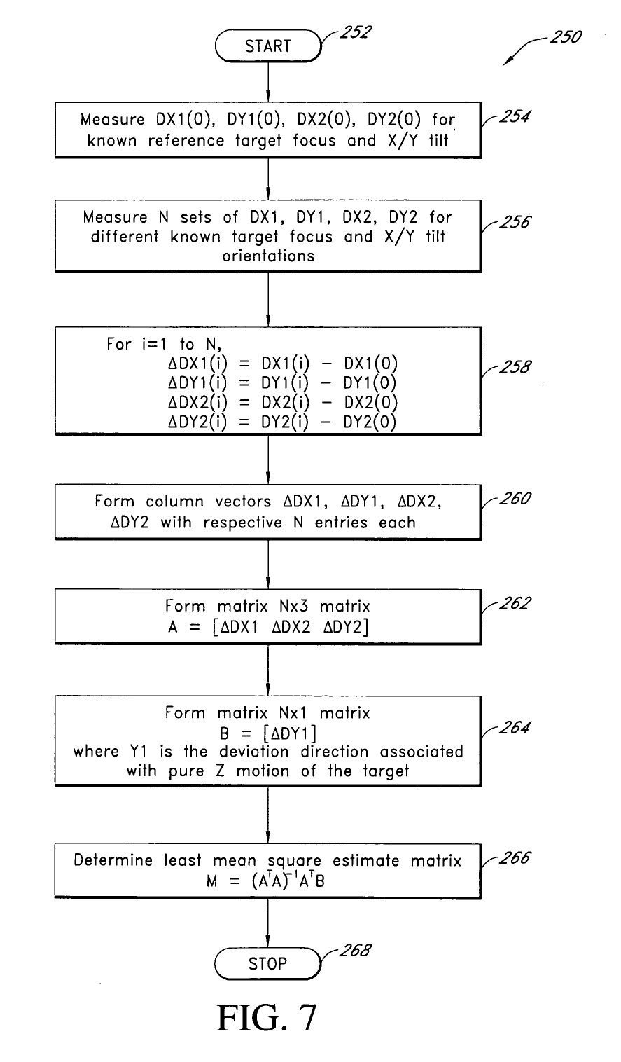

FIG. 7 illustrates a process 250 for calibrating the target position deviation detection system 128 (FIG. 4) and storing the calibration data to facilitate the transformation of PSD quantities DX1, DY1 (from the first PSD), DX2, DY2 (from the second PSD) into the target control space quantities ΔZ, Δθ_{X}, Δθ_{Y}. In certain embodiments, the process 250 may be performed once, at a regular interval, or as needed, without departing from the spirit of the present teachings.

The process 250 begins at a start state 252. In state 254 that follows, the process 250 measures the target-reflected lights at PSDs, with the target being in a known focus and X/Y tilt. The resulting values DX1(0), DY1(0) are obtained from the first PSD, and DX2(0), DY2(0) are obtained from the second PSD. In state 256 that follows, the process 250 moves the target to N different known Z focus and X/Y tilt orientations. At each orientation, the PSD quantities DX1, DY1, DX2, DY2 are measured and stored. In state 258 that follows, PSD position deviation array is formed for the N measurements as:
ΔDX1(i)=DX1(i)−DX1(0)
ΔDY1(i)=DY1(i)−DY1(0)
ΔDX2(i)=DX2(i)−DX2(0)
ΔDY2(i)=DY2(i)−DY2(0)
where i=1 to N. In state 260 that follows, column vectors \overline{ΔDX1}, \overline{ΔDY1}, \overline{ΔDX2}, \overline{ΔDY2} corresponding to the arrays ΔDX1(i), ΔDY1(i), ΔDX2(i), ΔDY2(i) are formed. These arrays facilitate formation of a matrix A in state 262 that follows where the column vectors \overline{ΔDX1}, \overline{ΔDX2}, \overline{ΔDY2} are combined to form a N×3 matrix A=[\overline{ΔDX1} \overline{ΔDX2} \overline{ΔDY2}]. The matrix A facilitates formation of a least mean square estimate matrix described below. In state 264 that follows an N×1 matrix B=[\overline{ΔDY1}] is formed. The matrix B also facilitates formation of the least mean square estimate matrix described below. The “preferential” treatment of the DY1 quantity is due to the selection of the Y1 direction being the direction associated with pure Z motion of the target. If a different coordinate system convention system is utilized with a different PSD direction associated with the pure Z target motion, the matrices A and B can be formed accordingly without departing from the spirit of the present teachings. In state 266 that follows, a least mean square estimate matrix M=(A^{T}A)⁻¹A^{T}B is formed from the matrices A and B, where A^{T} represents the transpose of the A matrix and the superscript (⁻¹) represent the inverse of a matrix. The matrix M characterizes the coupling of the pure Z target motion (characterized by the selected matrix B) with the X/Y tilt, and is utilized to uncouple a non-calibration measured target position (by the first and second PSDs) into the target control space quantities ΔZ, Δθ_{X}, and Δθ_{Y} in a manner described below. The calibration process 250 ends at a stop state 268.

The coupling matrix M determined in the foregoing manner allows the transformation of the PSD measured quantities DX1, DY1, DX2, DY2 to be transformed into the target control space quantities ΔZ, Δθ_{X}, and Δθ_{Y}. It will be appreciated that the foregoing matrix based technique is just one possible method of transforming the PSD values to target control space values. Other transformation methodologies may be used without departing from the novel concept of determining the control space deviation quantities from the PSDs' measurements.

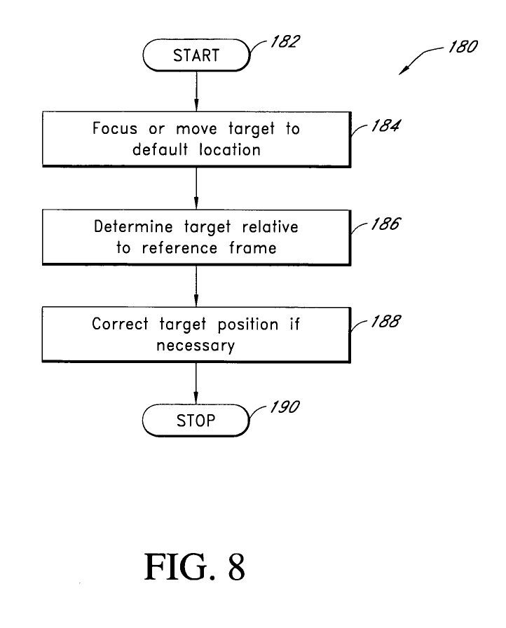

With the foregoing description of the target position deviation detection system, and the calibration method that facilitates target position deviation determination, use of the detection system during a data taking run is now described in greater detail. FIG. 8 illustrates a generalized process 180 for determining the target position relative to the reference frame, and making corrections as needed. The process 180 may be performed at the beginning of a given data taking run, after the target is mounted on a mounting location. In certain embodiments, such mounting process may require re-focusing of the target with respect to the reference frame. In other embodiments, the target may simply need to be verified for proper position with respect to the reference frame.

In certain embodiments, the process 180 is facilitated by the focusing component 110 and the controller 112 (FIG. 3A). The process 180 begins in a start state 182, and in state 184 that follows, the target is focused or moved to a default location with respect to the reference frame. As previously mentioned, in embodiments that do not require focusing after “loading” of targets, such step may not be necessary. In step 186 that follows, target's position relative to the reference frame is determined. The target position thus determined may include, fine Z position (after focusing), X/Y tilt, and/or the lateral position described above. In step 188 that follows, the target is moved to a correct position based on the position error(s) determined in step 186, and the process 180 ends in a stop state 190.

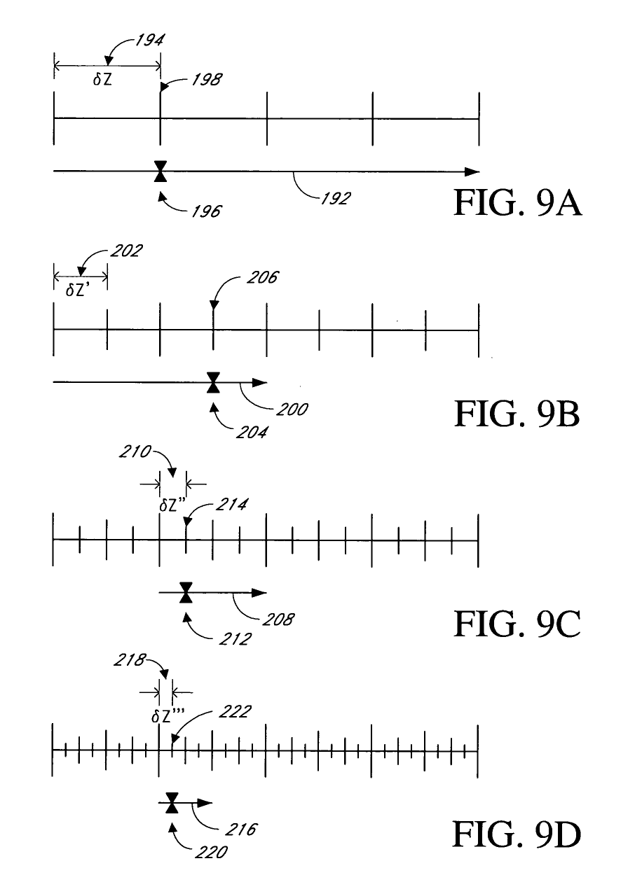

FIGS. 9A-D illustrate one possible focusing method that may occur in step 184 of the process 180 described above in reference to FIG. 8. The focusing method comprises positioning the target at a default focus location, and moving the target in δZ steps M times to cover a range that includes the current target position. At each δZ step, a focus quality metric is obtained. One possible method of determining the focus quality metric is described below in greater detail. The focusing method is depicted as having M=4 step movements. It will be understood, however, that M=4 is only for the purpose of description and is not intended to limit the method in any manner. Other methods may have more or less number of steps without departing from the spirit of the present teachings.

In FIG. 9A, an arrow 192 depicts the range of Z movements of the target in δZ steps 194, and a first indicator 196 indicates a first Z position 198 having the best focus quality metric for the δZ steps. FIG. 9B illustrates a next set of Z movements of the target in M smaller steps ΔZ′ 202 about the first Z position 198. In one implementation, δZ′ is approximately half of δZ. This set of Z movements is depicted as an arrow 200, with a second indicator 204 indicating a second Z position 206 having the best focus quality metric for the δZ′ steps. FIG. 9C illustrates a continuation of the focusing method, wherein an arrow 208 indicates a set of Z movements in M δZ″ 210 (δZ″=½δZ′) steps to yield a third best focus quality metric Z position 214 indicated by a third indicator 212.

The process of successively making the step size smaller continues until the step size becomes smaller than a predetermined value. FIG. 7D is a continuation of the movement set of FIG. 9C, wherein an arrow 216 indicates a set of Z movements in M δZ′″ 218 (δZ′″=½δZ″) steps to yield a fourth best focus quality metric Z position 222 indicated by a fourth indicator 220. In this exemplary focusing process the step size δZ′″ is less than the predetermined value; thus, the Z position 222 represents the “focused” position of the target. In certain embodiments, the predetermined value is set at approximately 0.3 μm, but it will be understood that such threshold value depends on the specific instrument and/or application, and may vary without departing from the spirit of the present teachings.

In certain embodiments, the focus quality metric is determined by evaluating a contrast value (CV) of a target image at the reference frame. As generally known, “autofocusing” may be achieved by an iteration of steps where in each step, some value associated with the quality of focus is determined. The “best” value among the values associated with the various steps may then represent the best focus for such step size focus movements. If the reference frame is a CCD having a selected center section with N pixels, one possible way of determining the focus related values is to evaluate the contrasts of the pixels with respect to some reference values. For example, contrast value CV can be evaluated as

$$CV = \frac{1}{E ( {x}_{i} )} \sqrt{\frac{1}{N} {\sum }_{i = 1}^{N} {( {x}_{i} - E ( {x}_{i} ) )}^{2}} \qquad ( 1 )$$

where xᵢ is i-th pixel intensity and E(xᵢ) is the mean pixel intensity for the i-th pixel. The CV is evaluated at each Z position of a given set of focus movements, and the position with the highest CV value is designated as the focus point for the given set of movements.

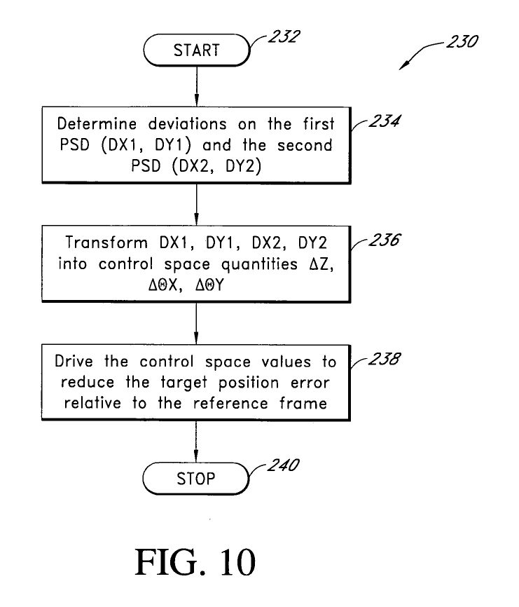

FIG. 10 illustrates a process 230 that elaborates the steps 186 and 188 (target position determination and correction) of the overall process 180 described above in reference to FIG. 8. At the beginning of the process 230 in state 232, the target has been positioned at a default location or focused by a method such as that described above in reference to FIG. 9. In state 234, the process 230 determines deviations of the target-reflected light at the first and second PSDs as quantities DX1, DY1, and DX2, DY2 from the respective PSD's reference point corresponding to the optimal target position. In step 236 that follows, the measured quantities DX1, DY1, DX2, DY2 from the PSDs are transformed into target control space quantities ΔZ, Δθ_{X}, and Δθ_{Y} in a manner described below in greater detail. In step 238 that follows, the process 230 drives the target control space values ΔZ, Δθ_{X}, and Δθ_{Y} to reduce the target position error relative to the reference frame. The process 180 ends at a stop state 240.

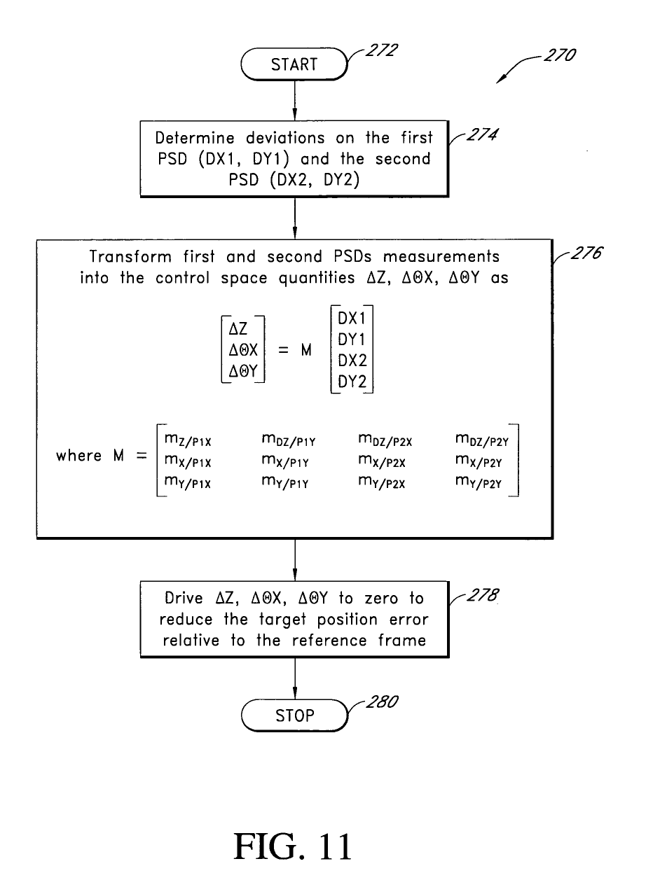

FIG. 11 illustrates a process 270 that elaborates on the transformation step 236 of the process 230 described above in reference to FIG. 10. The process 270 begins at a start state 272. In state 274 that follows, the deviations in the hit locations of the target reflected light at the first and second PSDs are determined as DX1, DY1 (for the first PSD), and DX2, DY2 (for the second PSD). In state 276 that follows, the four quantities DX1, DY1, DX2, DY2 are formed into a 4-element column vector, and transformed into a 3-element target control space column vector as

$$[ \begin{matrix}Δ Z \\ Δ {θ}_{x} \\ Δ {θ}_{y}\end{matrix} ] = [ \begin{matrix}DX1 \\ DY1 \\ DX2 \\ DY2\end{matrix} ] \qquad ( 2 )$$

where the M matrix is obtained from the calibration process 250 described above in reference to FIG. 7. Specifically,

$$M = [ \begin{matrix}{m}_{Z / P1X} & {m}_{DZ / P1Y} & {m}_{DZ / P2X} & {m}_{DZ / P2Y} \\ {m}_{X / P1X} & {m}_{X / P1Y} & {m}_{X / P2X} & {m}_{X / P2Y} \\ {m}_{Y / P1X} & {m}_{Y / P1Y} & {m}_{Y / P2X} & {m}_{Y / P2Y}\end{matrix} ]$$

where the subscripts denote the coupling between the target coordinate variable on the left of the “/” symbol and the PSD coordinate variable on the right side of the “/.”

The actual values of the matrix M elements m of course depend on the actual geometry of the reflected light and the positions of the PSDs with respect to the target. The geometry not only determines the coupling of between the target control space quantities ΔZ, Δθ_{X}, and Δθ_{Y}, but also the coupling in the detected values from the two PSDs for a given target deviation mode. That is, the ΔZ, Δθ_{X}, Δθ_{Y} deviations of the target result in the PSD detected deviations to be coupled by certain amounts. These PSD-to-PSD coupling values can be determined as follows:

$${Coupling}_{Z} = {A}_{Norm} \sqrt{\frac{{m}_{DZ / P2X}^{2} + {m}_{DZ / P2Y}^{2}}{{m}_{DZ / P1X}^{2} + {m}_{DZ / P1Y}^{2}}}$$

$${Coupling}_{Δ {θ}_{X}} = {A}_{Norm} \sqrt{\frac{{m}_{DX / P1X}^{2} + {m}_{DX / P1Y}^{2}}{{m}_{DZ / P2X}^{2} + {m}_{DZ / P2Y}^{2}}}$$

$${Coupling}_{Δ {θ}_{Y}} = {A}_{Norm} \sqrt{\frac{{m}_{DY / P1X}^{2} + {m}_{DY / P1Y}^{2}}{{m}_{DY / P2X}^{2} + {m}_{DY / P2Y}^{2}}}$$

where Aₙₒᵣₘ is a normalization constant.

Once the target control space quantities ΔZ, Δθ_{X}, and Δθ_{Y} are determined in the foregoing manner, the process 270 in state 278 drives these variables to zero to reduce the target position error relative to the reference frame. The process ends at a stop state 280.

The target control space quantities ΔZ, Δθ_{X}, and Δθ_{Y} determined in the foregoing manner describes the Z and X/Y tilt offsets of the target from its optimal position with respect to the reference frame. Given such information, the optical system may be adapted to move the target so as to drive these quantities to zero, thereby facilitating the improved positioning of the target with respect to the reference frame.

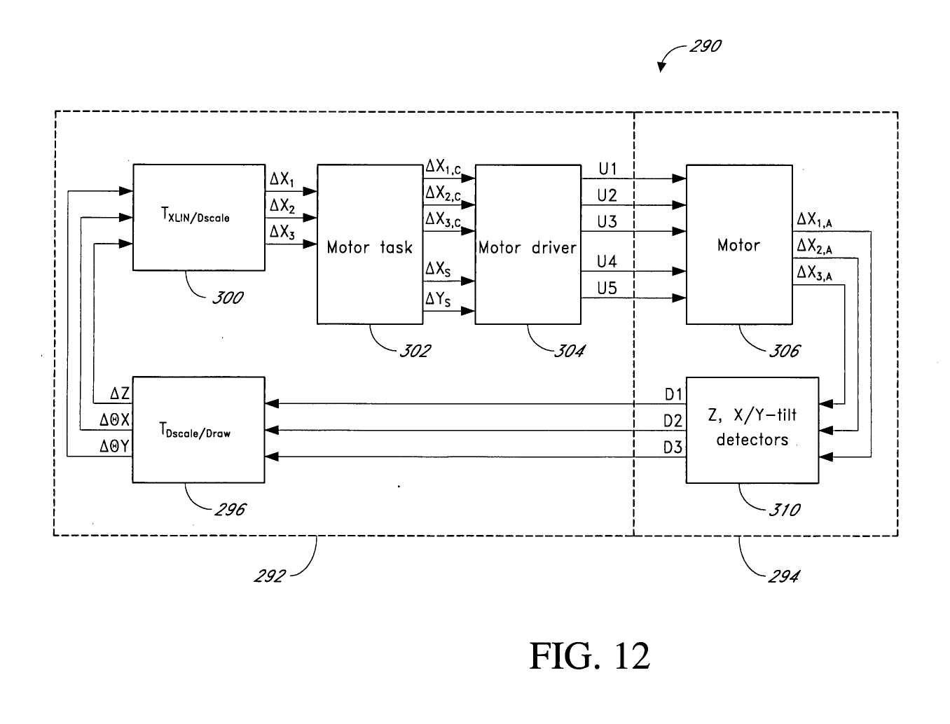

Once the target control space quantities ΔZ, Δθ_{X}, and Δθ_{Y} are determined, for example, in the manner described above in reference to FIGS. 10 and 11, such quantities may be utilized to correct the target position with respect to the reference frame. One possible system and method for achieving such correction is illustrated in FIG. 12 that depicts a functional block diagram of a target position control system 290. In certain embodiments, the control system 290 is configured to detect the target offset and drive the target to reduce the offset, thereby improving the position of the target. In certain embodiments, the target position control system 290 comprises a firmware portion 292 and a hardware portion 294.

The description of the feedback control system 290 begins at the hardware portion 294 at Z, X/Y-tilt PSDs 310 that function as described above. The PSDs output detected signals D1, D2, D3 that are input into a first transformer 296. The first transformer 296 transforms the PSD signals D1, D2, D3 into the target control space signals ΔZ, Δθ_{X}, and Δθ_{Y}. The target control space signals ΔZ, Δθ_{X}, and Δθ_{Y} are input into a second transformer 300 that transforms the input signals into signals ΔX₁, ΔX₂, ΔX₃ adapted for a motor tasker 302. The motor tasker 302 determines the target movement(s) to be made based on its input signals ΔX₁, ΔX₂, ΔX₃, and outputs signals ΔX_{1C}, ΔX_{2C}, ΔX_{3C}, and ΔX_{S}, ΔY_{S} adapted for a motor driver 304. The motor tasker output signals includes the target position correction signals ΔX_{1C}, ΔX_{2C}, ΔX_{3C}, as well as the lateral stage movement signals ΔX_{S}, ΔY_{S} to center the target relative to the reference frame. The motor driver 304 transforms the motor tasker 302 signals ΔX_{1C}, ΔX_{2C}, ΔX_{3C}, ΔX_{S}, ΔY_{S} into their motor-compatible signals U₁, U₂, U₃, U₄, U₅. The motor-compatible signals U₁, U₂, U₃, U₄, U₅ cause a motor 306 to move the target, causing a new set of target position deviation values ΔX_{1A}, ΔX_{2A}, ΔX_{3A} to be generated and detected by the Z, X/Y-tilt PSDs 310. Such a feedback control loop may be repeated as necessary to reduce the deviation values ΔZ, Δθ_{X}, and Δθ_{Y} to acceptable levels.

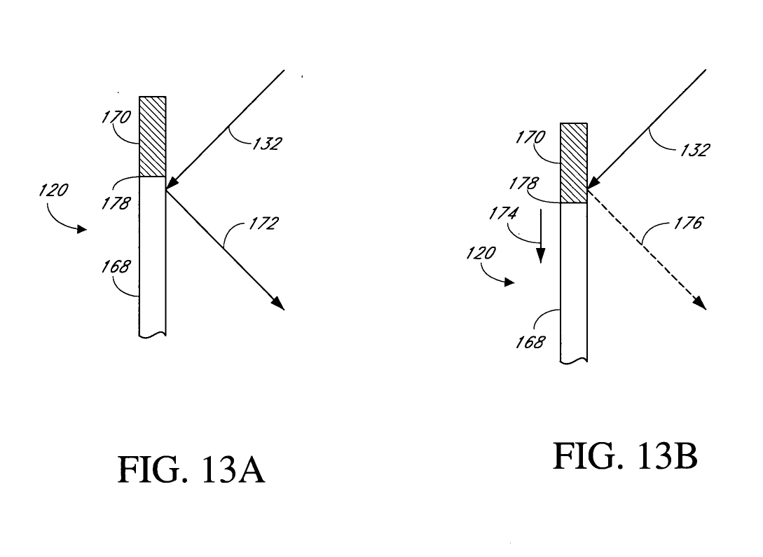

In one aspect, the present teachings also relates to a target position deviation detection system that allows the target to be positioned at an optimal lateral position (“centered”) with respect to the signal acquisition frame. In certain embodiments, the centering is achieved by detecting the edges of the target, as illustrated in FIGS. 13A and B. In the expanded side view, the target 120 is depicted to include an active portion 168 bounded by a border 170 so as do define an edge 178 therebetween. FIGS. 13A, B illustrate a transition of the incidence point of the incident light 132 from the active portion 168 to the border 170 as the target 120 is moved laterally as indicated by an arrow 174. While the incident light 132 impinges on the active portion 168 of the target 120 as in FIG. 13A, a specularly reflected light 172 has one or more properties associated with reflection from the active portion's surface. When the incident light impinges on the border 170 of the target as in FIG. 13B, a specularly reflected light 176 has one or more properties associated with reflection from the border surface. For example, if the active portion surface is more reflective than the border surface, the reflected light 172 has a higher intensity than the reflected light 176. In another example, if the border surface is less smooth than the active portion surface, the reflected light 176 may have a wider beam profile (diffused) than that of the reflected light 172.

In certain embodiments, the reflected lights 172 and 176 are detected and measured by one or both of the two PSDs described above in reference to FIG. 4. The PSDs may be configured to detect changes in the intensity of the reflected light. The diffused reflected light, if diffused more than the PSD element dimension, may be detected by a plurality of elements of the PSD(s). In such a measurement, the presence of diffused beam may be sufficient to indicate the transition of the reflecting surface.

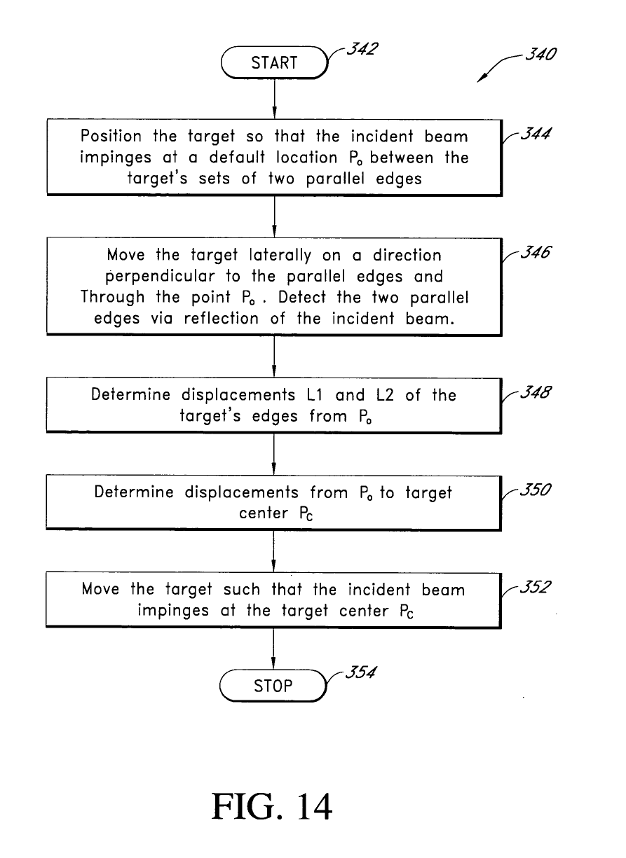

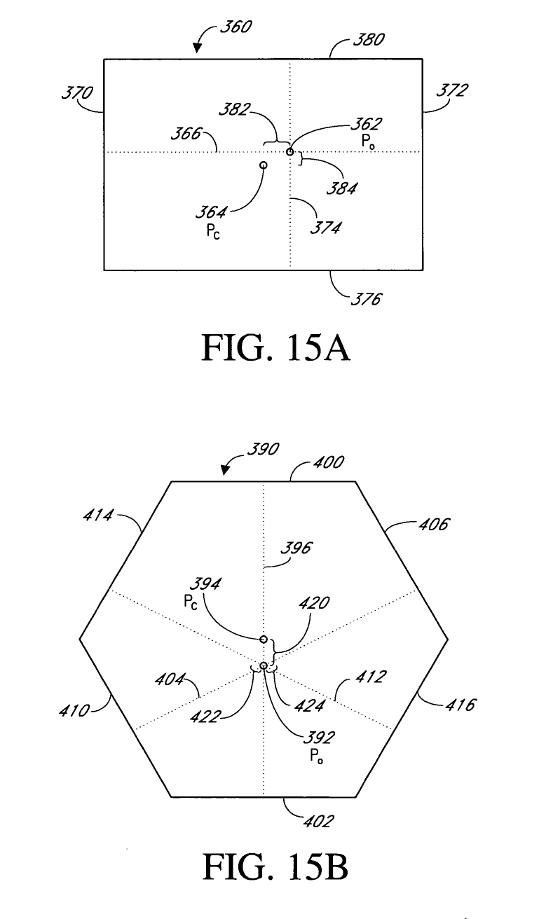

FIGS. 14 and 15 illustrate one possible method of positioning the target at a desirable lateral position with respect to the reference frame. In certain embodiments, the desirable lateral position comprises centering the target with respect to the reference frame. A target centering process 340 describes centering of a target along a single lateral direction. As seen in FIGS. 15A, B, a target may have exemplary shapes such as a rectangle or a hexagon. It will be appreciated that the centering concept and implementation may be extended to include centering along other directions to accommodate centering of various target shapes without departing from the spirit of the present teachings.

A target centering process 340 begins at a start state 342, and in state 344 that follows, the process positions the target so that the incident beam of light impinges at a default location Pₒ somewhere between the target's sets of parallel edges. In state 346 that follows, the target is moved in a direction perpendicular to the parallel edges and through the location Pₒ. As the target is moved laterally, the target-reflected light is monitored by one or more of the PSDs to detect the two parallel edges. In state 348 that follows, the process 340 determines displacements L1 and L2 of the two parallel edges from the location Pₒ. In state 350 that follows, the process 340 determines the displacement from the location Pₒ to the target center P_{C} determined from L1 and L2. In certain implementations, the displacement magnitude |Pₒ−P_{C}| may be determined by evaluating ½|L1−L2|. The direction of displacement is towards the side of larger of L1 and L2. In state 352 that follows, the target is moved by the displacement determined in step 350 such that the incident light beam impinges at the target center P_{C}. The process 340 ends at a stop state 354.

The centering process 340 described in reference to FIG. 14 may be applied to the exemplary target shapes illustrated in FIGS. 15A and B. A rectangular target 360 comprises two sets of parallel edges 376, 380, and 370, 372. Point Pₒ is indicated as 362, and P_{C} as 364. Moving the target 360 such that the incident light beam impinges along a line 374 allows detection of edges 376 and 380 in a manner described above. Such detection allows determination and corrective move of a displacement 384 that moves the incident light beam impinging point from Pₒ to P_{C} along the line 374. In a similar manner, the center of the target with respect to the edges 370 and 372 is determined so as to move the impinging point by a displacement 382 along a line 366.

FIG. 15B illustrates a hexagonal shaped target 390 having three sets of parallel edges 400, 402; 406, 410; 414, 416. Point Pₒ is indicated as 392, and P_{C} as 394. Moving the target 390 such that the light beam's incident point moves along a line 396 allows detection of the edges 400 and 402, thereby allowing determination of a displacement 420 from Pₒ to P_{C} along the line 396. Similarly, the displacements 424 and 422 along lines 404 and 412, respectively, are determined.

It will be appreciated that the foregoing method of centering the target can be applied to other target shapes without departing from the spirit of the present teachings. Preferably, the target shape has symmetry and sets of parallel edges. However, any other target shapes without symmetry and/or parallel edges may also be adapted so as to allow centering in the foregoing manner. For example, the active portion of the target may not be symmetric or have parallel edges. Such a target may be mounted on a symmetric target holder having parallel edges, and such target holder may be mounted on the stage. By knowing the spatial relationship between the target and the target holder, the above described centering technique may be utilized in centering the target with respect to the reference frame.

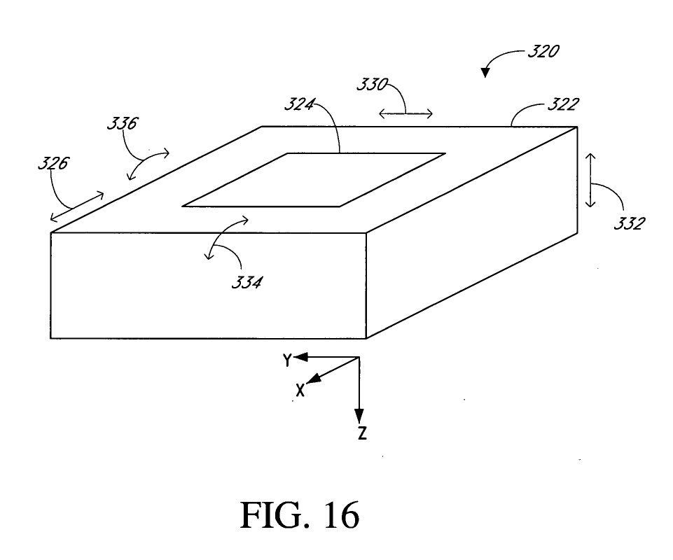

The target position movements determined and actuated in the foregoing manner may be implemented by a stage assembly 320 illustrated in FIG. 16. The stage assembly 320 comprises a stage 322 and a target 324 mounted thereon. The stage 322 can be adapted to be moved along a Z-direction 332, laterally along X and Y directions 326 and 330. The stage 322 may also be adapted to be tilted so as to cause an X-axis tilt 334 and a Y-axis tilt 336.

Although the above-disclosed embodiments of the present invention have shown, described, and pointed out the fundamental novel features of the invention as applied to the above-disclosed embodiments, it should be understood that various omissions, substitutions, and changes in the form of the detail of the devices, systems, and/or methods illustrated may be made by those skilled in the art without departing from the scope of the present invention. Consequently, the scope of the invention should not be limited to the foregoing description, but should be defined by the appended claims.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

1. A system for interrogating a sample using a probe array configured to be responsive to a plurality of particles wherein the probe array generates one or more identifiable signals following interaction with the sample particles and wherein the sample composition is resolved, at least in part, by identifying the signals associated with each constituent probe of the array, the system comprising:
an imaging device capable of identifying signals associated with the constituent probes of the probe array wherein the position of each constituent probe and the signal arising therefrom is used to identify the presence or absence of particles contained within the sample;
a focusing component that positions the imaging device and the probe array with respect to each other so as to obtain a desired focal orientation between the imaging device and the probe array;
a focus detection system that includes a plurality of detectors wherein the focus detection system directs a calibration beam towards the probe array which is reflected with an orientation dependent on the positioning of the array and wherein the calibration beam is subsequently split into a plurality of reflected beams which impinge upon the plurality of detectors such that the plurality of detectors detect the impingement positions of the plurality of reflected beams in at least two dimensions and wherein the focus detection system uses the at least two dimensional impingement positions to determine how to move the image capture device and the probe array with respect to each other in order to position the imaging device and the probe array in the desired focal orientation; and
a processing system that evaluates signals captured by the imaging device when the probe array and the imaging device are in a desired focal orientation.

2. The system of claim 1, wherein the desired focal orientation is selected to improve the ability of the processing system to determine the physical location on the probe array from which each signal originates.

3. The system of claim 1, wherein the desired focal orientation between the imaging device and the probe array is defined by at least the characteristics of (i) the deviation in the distance between the probe array and the imaging device (ΔZ), (ii) the tilt angle about a first axis θ_{X} and (iii) the tilt angle about a second axis θ_{Y}.

4. The system of claim 3, wherein the focusing component preferably adjusts the focal orientation between the imaging device and the probe array such that the deviation in the distance between the probe array and the imaging device (ΔZ) is less than a pre-selected deviation in the distance and such that the tilt angle about the first and second axes θ_{X} and θ_{Y} are such that the plane of the probe array is substantially parallel to a plane defined by the imaging device.

5. The system of claim 4, wherein the plurality of detectors comprise a first and a second detector wherein each of the first and second detectors have a pre-selected location where the reflected calibration beams will impinge when the probe array and the imaging device are in the desired orientation and wherein each of the first and second detectors provide dimensional coordinates indicative of the offset between the actual point of impingement of the reflected beams and the pre-selected locations on the first and second detectors respectively.

6. The system of claim 5, wherein the dimensional coordinates are mathematically transformed using a calibration data set to define the values ΔZ, θ_{X} and θ_{Y}.

7. The system of claim 6, wherein the mathematical transformation is performed by a least mean square estimate matrix that operates on a given set of dimensional coordinates to yield estimates of corresponding ΔZ, θ_{X} and θ_{Y} values.

8. The system of claim 6, wherein the calibration data set comprises data points corresponding to dimensional coordinates obtained when the probe array is positioned at known ΔZ, θ_{X} and θ_{Y} focal orientations.

9. The system of claim 8, wherein the data points corresponding to dimensional coordinates at known ΔZ, θ_{X} and θ_{Y} focal orientations are expressed as a transformation matrix (M) representative of a least mean square estimate of ΔZ, θ_{X} and θ_{Y} variables based on a given set of dimensional coordinates.

10. The system of claim 1, further comprising a coarse focus system that positions the probe array proximate a desired location with respect to the imaging device prior to utilizing the focus detection system.

11. The system of claim 10, wherein the coarse focus system comprises an iteration of a series of positional movements of the analysis platform wherein for a given series of positional movements, a best coarse focus is determined by selecting the position that yields the highest coarse focus metric value and wherein the next series of positional movements comprises movement steps that are approximately half of the step size of the given series of movements, wherein such iteration of positional movements are performed until the step size is less than some specified value.

12. The system of claim 11, wherein the coarse focus metric value comprises a contrast value determined by averaging the contrast the image at the image capture device.

13. An optical system comprising:
an analysis platform comprising a sample disposed on a probe array wherein each probe is configured to be responsive to a specific particle and wherein when the probe array is exposed to the sample, the probes generate identifiable signals based on the interaction of the probes with specific particles within the sample;
an image capture device that captures an image of the probe array so as to be able to identify the position of the signal generating probes to thereby identify the composition of specific particles contained within the sample;
a focusing component that positions the image capture device and the analysis platform with respect to each other so as to obtain a desired focal orientation between the image capture device and the analysis platform;
a focus detection system that includes a calibration data set and a plurality of detectors wherein the focus detection system directs an energy beam towards the array of probes which is then reflected with an orientation dependent on the positioning of the array and wherein the reflected energy beam is split into a plurality of reflected beams which impinge upon the plurality of detectors such that the plurality of detectors detect the impingement positions of the plurality of reflected beams in at least two dimensions and wherein the focus detection system uses the at least two dimensional impingement positions and the calibration data to determine how the focusing component must relatively move the image capture device and the analysis platform with respect to each other in order to relatively position the image capture device and the analysis platform in the desired focal orientation; and
a processing system that evaluates the image captured by the image capture device when the analysis platform and the image capture device are in the desired focal orientation wherein the desired focal orientation is selected to improve the ability of the processing system to determine the physical location on the array of probes of the generated signals to thereby permit identification of the particle composition in the sample based upon the location of signals detected in the probe array.

14. The system of claim 13, wherein the probe array comprises a plurality of host sites adapted to selectively interact with a selected type of particle such that the spatial arrangement of the host sites allows spatial separation of particles from a mixture of different particles, wherein the host sites are approximately coplanar such that host sites define a reflecting surface for the energy beam.

15. The system of claim 14, wherein the particles are of nucleotide or protein origin.

16. The system of claim 14, wherein the particles comprise DNA or RNA molecules.

17. The system of claim 14, wherein the particles are labeled with markers that emit a detectable signal when subjected to an excitation energy.

18. The system of claim 14, wherein each host site comprises a fiber tip such that the probe array is formed by a bundle of the fibers with the tips being approximately coplanar with each other.

19. The system of claim 13, wherein the desired focal orientation between the image capture device and the analysis platform is defined by at least the characteristics of (i) the deviation in the distance between the analysis platform and the image capture device (ΔZ), (ii) the tilt angle about a first axis θ_{X} and (iii) the tilt angle about a second axis θ_{Y}.

20. The system of claim 19, wherein the focusing component preferably adjusts the focal orientation between the image capture device and the analysis platform such that the deviation in the distance between the analysis platform and the image capture device (ΔZ) is less than a pre-selected deviation in the distance and such that the tilt angle about the first and second axes θ_{X} and θ_{Y} are such that the plane of the analysis platform is substantially parallel to a plane defined by the image capture device.

21. The system of claim 20, wherein the plurality of detectors comprise a first and a second two dimensional detectors wherein each of the first and second detectors have a pre-selected location where the reflected energy beams will impinge when the analysis platform and the image capture device is in the desired orientation and wherein each of the first and second detectors provide two dimensional coordinates indicative of the offset between the actual point of impingement of the reflected beams and the pre-selected locations on the first and second detectors respectively.

22. The system of claim 21, wherein the two sets of dimensional coordinates are mathematically transformed using the calibration data set to define the values ΔZ, θ_{X} and θ_{Y}.

23. The system of claim 22, wherein the mathematical transformation is performed by a least mean square estimate matrix that operates on a given set of dimensional coordinates to yield estimates of corresponding ΔZ, θ_{X} and θ_{Y} values.

24. The system of claim 13, wherein the calibration data set comprises data points corresponding to dimensional coordinates obtained when the analysis platform is positioned by the focusing component at known focal orientations.

25. The system of claim 24, wherein the data points corresponding to dimensional coordinates at known focal orientations are expressed as a transformation matrix (M) that represents a least mean square estimate of the focal orientation based on a given set dimensional coordinates.

26. The system of claim 13, further comprising a coarse focus system that positions the analysis platform proximate a desired location with respect to the image capture device prior to utilizing the focus detection system.

27. The system of claim 26, wherein the coarse focus system comprises an iteration of a series of Z movements of the analysis platform wherein for a given series of Z movements, a best coarse focus is determined by selecting the Z position that yields the highest coarse focus metric value and wherein the next series of Z movements comprises movement steps that are approximately half of the step size of the given series of movements, wherein such iteration of Z movements are performed until the step size is less than some specified value.

28. The system of claim 27, wherein the coarse focus metric value comprises a contrast value determined by averaging the contrast the image at the image capture device.

29. A system for interrogating a sample via an array of probes positioned on an analysis platform wherein each probe is configured to be responsive to a specific particle having unique identifying characteristics and wherein when the array of probes is exposed to the sample, the probes generate an identifiable signal based on the interaction of the probes with specific particles within the sample based upon the unique identifying characteristics of the specific particle, the system comprising:
an image capture device that captures a two dimensional image of the array of probes so as to be able to identify the position of the signal generating probes to thereby identify the composition of specific particles contained within the sample;
a focusing component that positions the image capture device and the analysis platform with respect to each other so as to obtain a desired focal orientation between the image capture device and the analysis platform;
a focus detection system that includes a calibration data set and a plurality of detectors wherein the focus detection system directs an energy beam towards the array of probes which is then reflected with an orientation dependent on the positioning of the array and wherein the reflected energy beam is split into a plurality of reflected beams which impinge upon the plurality of detectors such that the plurality of detectors detect the impingement positions of the plurality of reflected beams in at least two dimensions and wherein the focus detection system uses the at least two dimensional impingement positions and the calibration data to determine how the focusing component must relatively move the image capture device and the analysis platform with respect to each other in order to relatively position the image capture device and the analysis platform in the desired focal orientation; and
a processing system that evaluates the image captured by the image capture device when the analysis platform and the image capture device are in the desired focal orientation wherein the desired focal orientation is selected to improve the ability of the processing system to determine the physical location on the array of probes of the generated signals to thereby permit identification of the particle composition in the sample based upon the location of signals detected in the array.

30. A method for obtaining a selected focal orientation between an imaging device and a probe array to resolve signals corresponding to a plurality of discrete probe species, the method comprising:
directing a calibration beam towards the probe array in such a manner so as to produce a reflected calibration beam having an orientation dependent, in part, upon the positioning of the probe array;
splitting the reflected calibration beam into two or more reflected beams which subsequently impinge upon two or more beam detectors wherein the beam detectors detect the impingement positions of the two or more reflected beams in at least two dimensions;
evaluating the impingement positions of the two or more reflected beams to determine the current positioning between the imaging device and the probe array;
calculating positional adjustments necessary to position the imaging device and the probe array with respect to each other in the selected focal orientation; and
repositioning the imaging device and the probe array according to the calculated positional adjustments to achieve the selected focal orientation.

31. The method of claim 30, wherein the selected focal orientation yields improved signal resolution when determining the physical location on the probe array from which each signal originates.

32. The method of claim 30, wherein the selected focal orientation between the imaging device and the probe array is defined by at least the characteristics of (i) the deviation in the distance between the probe array and the imaging device (ΔZ), (ii) the tilt angle about a first axis θ_{X} and (iii) the tilt angle about a second axis θ_{Y}.

33. The method of claim 32, wherein the focal orientation between the imaging device and the probe array is adjusted such that the deviation in the distance between the probe array and the imaging device (ΔZ) is less than a pre-selected deviation in the distance and such that the tilt angle about the first and second axes θ_{X} and θ_{Y} are such that the plane of the probe array is substantially parallel to a plane defined by the imaging device.

34. The method of claim 30, wherein the imaging device receives the signals emitted by the probe array and subsequently generates an image representative of the probe array surface.

35. The method of claim 34, wherein the imaging device which receives the signals emitted by the probe array comprises a CCD element or photosensitive pixel array.

36. The method of claim 30, wherein calculating positional adjustments further comprises determining a pre-selected location where the split reflected beams will impinge upon the beam detectors when the probe array and the imaging device are in the selected orientation and wherein the first and second detectors provide dimensional coordinates indicative of the offset between the actual point of impingement of the reflected beams and the pre-selected locations on the beam detectors to provide a means for focal repositioning.

37. The method of claim 36, wherein the sets of dimensional coordinates are mathematically transformed using a calibration data set.

38. The method of claim 37, wherein the mathematical transformation is performed by a least mean square estimate matrix that operates on the sets of dimensional coordinates to yield estimates of deviation distance and tilt angles between the imaging device and the probe array.

39. The method of claim 37, wherein the calibration data set comprises data points corresponding to dimensional coordinates obtained when the probe array is positioned in known focal orientations.

40. The method of claim 39, wherein the data points corresponding to the dimensional coordinates at the known focal orientations are represented as a transformation matrix of a least mean square estimate of the deviation distance and tilt angles between the imaging device and the probe array.

41. The method of claim 30, further comprising performing a coarse focusing that positions the probe array proximate a desired location with respect to the imaging device prior to repositioning the imaging device and the probe array according to the calculated positional adjustments to achieve the selected focal orientation.

42. The method of claim 41, wherein the coarse focusing comprises an iteration of a series of movements of the probe array wherein for a given series of movements, a best coarse focus is determined by selecting the position that yields a highest coarse focus metric value and wherein the next series of movements comprises movement steps that are approximately half of the step size of the given series of movements, wherein such iteration of movements are performed until the step size is less than a specified threshold.

43. The method of claim 42, wherein the coarse focus metric value is determined by averaging the contrast of the image of the probe array acquired by the imaging device.

44. A method for determining a focal orientation between an imaging device and a target, the method comprising:
directing a calibration beam towards the target in such a manner so as to produce a reflected calibration beam having an orientation dependent, in part, upon the positioning of the target;
splitting the reflected calibration beam into two or more reflected beams which subsequently impinge upon two or more beam detectors wherein the beam detectors detect the impingement positions of the two or more reflected beams in at least two dimensions; and
evaluating the impingement positions of the two or more reflected beams to determine the current positioning between the imaging device and the target.

45. The method of claim 44, further comprising calculating positional adjustments necessary to position the imaging device and the target with respect to each other in the selected focal orientation.

46. The method of claim 45, further comprising repositioning the imaging device and the target according to the calculated positional adjustments to achieve a desired focal orientation.
